(19) United States
(12) Patent Application Publication
(10) Pub. No.: US 2019/0073305 A1
(43) Pub. Date: Mar. 7, 2019

(54) Reuse Aware Cache Line Insertion And Victim Selection In Large Cache Memory

(71) Applicant: QUALCOMM Incorporated, San Diego, CA (US)

(72) Inventors: Farrukh Hijaz, San Diego, CA (US); George Patsilaras, San Diego, CA (US)

(21) Appl. No.: 15/695,732

(22) Filed: Sep. 5, 2017

(51) Int. Cl. G06F 12/0846

(52) U.S. Cl. CPC G06F 12/0848; G06F 2212/225

(57) ABSTRACT

Various aspects include methods for implementing reuse aware cache line insertion and victim selection in large cache memory on a computing device. Various aspects may include receiving a cache access request for a cache line in a higher level cache memory, updating a cache line reuse counter datum configured to indicate a number of accesses to the cache line in the higher level cache memory during a reuse tracking period in response to receiving the cache access request, evicting the cache line from the higher level cache memory, determining a cache line locality classification for the evicted cache line based on the cache line reuse counter datum, inserting the evicted cache line into a last level cache memory, and updating a cache line locality classification datum for the inserted cache line.

### BACKGROUND

Conventionally, a cache line evicted from a higher level cache memory is generally inserted in a position that takes the most time for it to get evicted from this level of cache memory. This policy works for higher level cache memories, such as L1 cache memory and L2 cache memory, where a low locality cache line will be evicted relatively quickly. However, in larger last level cache memory, it takes more time to evict a cache line and during that time the cache line occupies valuable cache capacity. Additionally, low locality cache lines evicted from a higher level cache memory can replace higher locality cache lines in the last level cache memory. These low locality cache lines may never be used again and are eventually evicted from the last level cache memory. For an access of the higher locality cache line evicted from the last level cache memory, the higher locality cache line needs to be brought back from random access memory (RAM), burning extra power and incurring higher access latency than accessing the higher locality cache line in the last level cache memory. The insertion of some cache lines with no/very low locality in the last level cache memory also burns power and may not be necessary.

Cache replacement policies are used to decide which cache line to evict from a fully occupied cache set of a cache memory in response to a cache line insertion. Generally, the goal of such cache replacement policies is to retain higher locality data in the cache memories. This cache replacement policy works for higher level cache memory, such as L1 cache memory and L2 cache memory. However, further down the cache hierarchy the locality information is lost due to filtering of access patterns by the higher level cache memories. This can impact performance and power as larger caches with no locality information become less effective.

### SUMMARY

Various disclosed aspects may include apparatuses and methods for implementing reuse aware cache line insertion and victim selection in large cache memory on a computing device. Various aspects may include receiving a cache access request for a cache line in a higher level cache memory, updating a cache line reuse counter datum configured to indicate a number of accesses to the cache line in the higher level cache memory during a reuse tracking period in response to receiving the cache access request, evicting the cache line from the higher level cache memory, determining a cache line locality classification for the evicted cache line based on the cache line reuse counter datum, inserting the evicted cache line into a last level cache memory, and updating a cache line locality classification datum for the inserted cache line.

In some aspects, updating a cache line reuse counter datum configured to indicate a number of accesses to the cache line during a reuse tracking period in response to receiving the cache access request may include updating the cache line reuse counter datum in a cache line reuse counter field in the cache line in the higher level cache memory.

In some aspects, inserting the evicted cache line into a last level cache memory may include inserting the evicted cache line into a cache line in the last level cache memory, and updating a cache line locality classification datum for the inserted cache line may include updating the cache line locality classification datum in a cache line locality classification field in the cache line in the last level cache memory.

In some aspects, determining a cache line locality classification for the evicted cache line based on the cache line reuse counter datum may include comparing the cache line reuse counter datum to a locality classification threshold. Some aspects may further include selecting a position corresponding to the cache line locality classification in an eviction order of an eviction policy for the last level cache memory.

In some aspects, selecting a position corresponding to the cache line locality classification in an eviction order of an eviction policy for the last level cache memory may include selecting a first position configured to be evicted prior to a second position in response to determining the cache line locality classification for the evicted cache line is a first cache line locality classification, in which the first cache line locality classification is configured to indicate cache line locality less than a second cache line locality classification, and selecting the second position in response to determining the cache line locality classification for the evicted cache line is the second cache line locality classification.

Some aspects may further include determining a victim cache line of the last level cache memory based on a locality classification datum of the victim cache line, and evicting the victim cache line from the last level cache memory. In some aspects, inserting the evicted cache line into a last level cache memory may include inserting the evicted cache line into a cache line in the last level cache memory vacated by evicting the victim cache line from the last level cache memory, and updating a cache line locality classification datum for the inserted cache line may include updating the cache line locality classification datum in a cache line locality classification field in the in the cache line in the last level cache memory.

In some aspects, determining a victim cache line of the last level cache memory based on a locality classification datum of the victim cache line may include determining whether a victim cache line candidate has a first locality classification. Some aspects may further include determining whether the victim cache line candidate has a second locality classification in response to determining that the victim cache line does not have a first locality classification.

In some aspects, determining a victim cache line of the last level cache memory based on a locality classification datum of the victim cache line may include determining whether a victim cache line candidate has a first locality classification. Some aspects may further include determining whether multiple victim cache line candidates have the first locality classification in response to determining that the victim cache line candidate has the first locality classification, and selecting the victim cache line from the multiple victim cache line candidates based on a position in an eviction order of an eviction policy for the last level cache memory in response to determining that the multiple victim cache line candidates have the first locality classification.

Various aspects include computing devices having a processor, a higher level cache memory, a last level cache memory, and a cache memory manager configured to perform operations of any of the methods summarized above. Various aspects include computing devices having means for performing functions of any of the methods summarized above. Various aspects include a non-transitory processor readable storage medium on which are stored processor-executable instructions configured to cause a processor to perform operations of any of the methods summarized above.

### BRIEF DESCRIPTION OF THE DRAWINGS

The accompanying drawings, which are incorporated herein and constitute part of this specification, illustrate example aspects of various aspects, and together with the general description given above and the detailed description given below, serve to explain the features of the claims.

FIG. 1 is a component block diagram illustrating a computing device suitable for implementing various aspects.

FIG. 2 is a component block diagram illustrating components of a computing device suitable for implementing various aspects.

FIGS. 3A-3C are block diagrams illustrating an example higher level cache memory reuse aware system suitable for implementing various aspects.

FIGS. 4A-4C are block diagrams illustrating an example last level cache memory reuse aware system suitable for implementing various aspects.

FIG. 5 is a block diagram illustrating an example last level cache memory eviction order according to an eviction policy combined with reuse aware cache line insertion and victim selection suitable for implementing various aspects.

FIG. 6 is a process flow diagram illustrating a method for reuse tracking of a cache line in a higher level cache memory according to an aspect.

FIG. 7 is a process flow diagram illustrating a method for reuse aware cache line insertion and victim selection in large cache memory according to an aspect.

FIG. 8 is a process flow diagram illustrating a method for reuse aware cache line insertion with least recently used eviction protocol in large cache memory according to an aspect.

FIG. 9 is a process flow diagram illustrating a method for reuse aware cache line insertion with not most recently used eviction protocol in large cache memory according to an aspect.

FIG. 10 is a process flow diagram illustrating a method for reuse aware cache line victim selection in large cache memory according to an aspect.

FIG. 11 is a component block diagram illustrating an example mobile computing device suitable for use with the various aspects.

FIG. 12 is a component block diagram illustrating an example mobile computing device suitable for use with the various aspects.

FIG. 13 is a component block diagram illustrating an example server suitable for use with the various aspects.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various aspects may include methods, and computing devices executing such methods for implementing reuse aware cache line insertion and victim selection in large cache memory. The apparatus and methods of the various aspects may include reuse counters configured for tracking reuse of a cache line in a higher level cache and locality classification of the cache line in a last level cache. Various aspects may include reuse tracking of the cache line in the higher level cache, position selection for the cache line evicted from the higher level cache to the last level cache using a locality classification of the cache line, victim cache line selection in the last level cache for the cache line evicted from the higher level cache, and cache line insertion in the last level cache of the cache line evicted from the higher level cache.

The terms “computing device” and “mobile computing device” are used interchangeably herein to refer to any one or all of cellular telephones, smartphones, personal or mobile multi-media players, personal data assistants (PDA's), laptop computers, tablet computers, convertible laptops/tablets (2-in-1 computers), smartbooks, ultrabooks, netbooks, palm-top computers, wireless electronic mail receivers, multimedia Internet enabled cellular telephones, mobile gaming consoles, wireless gaming controllers, and similar personal electronic devices that include a memory, and a programmable processor. The terms “computing device” and “mobile computing device” may further refer to Internet of Things (IoT) devices, including wired and/or wirelessly connectable appliances and peripheral devices to appliances, décor devices, security devices, environment regulator devices, physiological sensor devices, audio/visual devices, toys, hobby and/or work devices, IoT device hubs, etc. The terms “computing device” and “mobile computing device” may further refer to components of personal and mass transportation vehicles. The term “computing device” may further refer to stationary computing devices including personal computers, desktop computers, all-in-one computers, workstations, super computers, mainframe computers, embedded computers, servers, home media computers, and game consoles.

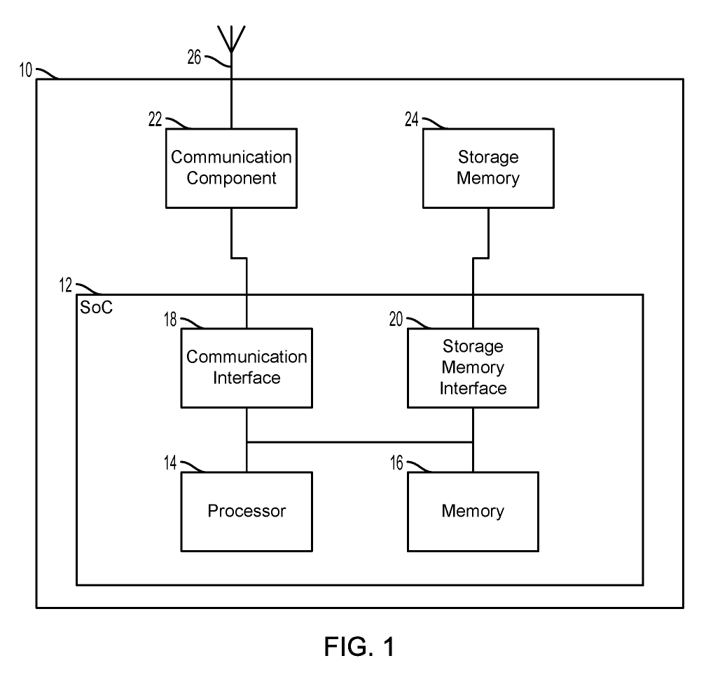

FIG. 1 illustrates a system including a computing device 10 suitable for use with the various aspects. The computing device 10 may include a system-on-chip (SoC) 12 with a processor 14, a memory 16, a communication interface 18, and a storage memory interface 20. The computing device 10 may further include a communication component 22, such as a wired or wireless modem, a storage memory 24, and an antenna 26 for establishing a wireless communication link. The processor 14 may include any of a variety of processing devices, for example a number of processor cores.

The term “system-on-chip” (SoC) is used herein to refer to a set of interconnected electronic circuits typically, but not exclusively, including a processing device, a memory, and a communication interface. A processing device may include a variety of different types of processors 14 and processor cores, such as a general purpose processor, a central processing unit (CPU), a digital signal processor (DSP), a graphics processing unit (GPU), an accelerated processing unit (APU), a subsystem processor of specific components of the computing device, such as an image processor for a camera subsystem or a display processor for a display, an auxiliary processor, a single-core processor, and a multicore processor. A processing device may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

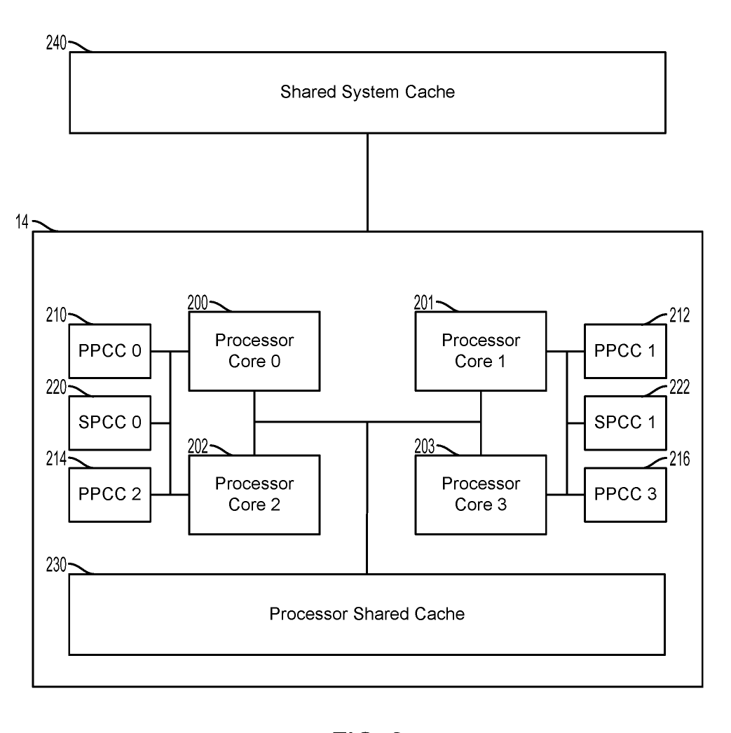

An SoC 12 may include one or more processors 14. The computing device 10 may include more than one SoC 12, thereby increasing the number of processors 14 and processor cores. The computing device 10 may also include processors 14 that are not associated with an SoC 12. Individual processors 14 may be multicore processors as described below with reference to FIG. 2. The processors 14 may each be configured for specific purposes that may be the same as or different from other processors 14 of the computing device 10. One or more of the processors 14 and processor cores of the same or different configurations may be grouped together. A group of processors 14 or processor cores may be referred to as a multi-processor cluster.

The memory 16 of the SoC 12 may be a volatile or non-volatile memory configured for storing data and processor-executable code for access by the processor 14. The computing device 10 and/or SoC 12 may include one or more memories 16 configured for various purposes. One or more memories 16 may include volatile memories such as random access memory (RAM) or main memory, cache memory, or flash memory. These memories 16 may be configured to temporarily hold a limited amount of data received from a data sensor or subsystem, data and/or processor-executable code instructions that are requested from non-volatile memory, loaded to the memories 16 from non-volatile memory in anticipation of future access based on a variety of factors, and/or intermediary processing data and/or processor-executable code instructions produced by the processor 14 and temporarily stored for future quick access without being stored in non-volatile memory.

The memory 16 may be configured to store data and processor-executable code, at least temporarily, that is loaded to the memory 16 from another memory device, such as another memory 16 or storage memory 24, for access by one or more of the processors 14. The data or processor-executable code loaded to the memory 16 may be loaded in response to execution of a function by the processor 14. Loading the data or processor-executable code to the memory 16 in response to execution of a function may result from a memory access request to the memory 16 that is unsuccessful, or a “miss,” because the requested data or processor-executable code is not located in the memory 16. In response to a miss, a memory access request to another memory 16 or storage memory 24 may be made to load the requested data or processor-executable code from the other memory 16 or storage memory 24 to the memory device 16. Loading the data or processor-executable code to the memory 16 in response to execution of a function may result from a memory access request to another memory 16 or storage memory 24, and the data or processor-executable code may be loaded to the memory 16 for later access.

The storage memory interface 20 and the storage memory 24 may work in unison to allow the computing device 10 to store data and processor-executable code on a non-volatile storage medium. The storage memory 24 may be configured much like an aspect of the memory 16 in which the storage memory 24 may store the data or processor-executable code for access by one or more of the processors 14. The storage memory 24, being non-volatile, may retain the information after the power of the computing device 10 has been shut off. When the power is turned back on and the computing device 10 reboots, the information stored on the storage memory 24 may be available to the computing device 10. The storage memory interface 20 may control access to the storage memory 24 and allow the processor 14 to read data from and write data to the storage memory 24.

Some or all of the components of the computing device 10 may be arranged differently and/or combined while still serving the functions of the various aspects. The computing device 10 may not be limited to one of each of the components, and multiple instances of each component may be included in various configurations of the computing device 10.

FIG. 2 illustrates components of a computing device suitable for implementing an aspect. The processor 14 may include multiple processor types, including, for example, a CPU and various hardware accelerators, such as a GPU, a DSP, an APU, subsystem processor, etc. The processor 14 may also include a custom hardware accelerator, which may include custom processing hardware and/or general purpose hardware configured to implement a specialized set of functions. The processors 14 may include any number of processor cores 200, 201, 202, 203. A processor 14 having multiple processor cores 200, 201, 202, 203 may be referred to as a multicore processor.

The processor 14 may have a plurality of homogeneous or heterogeneous processor cores 200, 201, 202, 203. A homogeneous processor may include a plurality of homogeneous processor cores. The processor cores 200, 201, 202, 203 may be homogeneous in that, the processor cores 200, 201, 202, 203 of the processor 14 may be configured for the same purpose and have the same or similar performance characteristics. For example, the processor 14 may be a general purpose processor, and the processor cores 200, 201, 202, 203 may be homogeneous general purpose processor cores. The processor 14 may be a GPU or a DSP, and the processor cores 200, 201, 202, 203 may be homogeneous graphics processor cores or digital signal processor cores, respectively. The processor 14 may be a custom hardware accelerator with homogeneous processor cores 200, 201, 202, 203.

A heterogeneous processor may include a plurality of heterogeneous processor cores. The processor cores 200, 201, 202, 203 may be heterogeneous in that the processor cores 200, 201, 202, 203 of the processor 14 may be configured for different purposes and/or have different performance characteristics. The heterogeneity of such heterogeneous processor cores may include different instruction set architecture, pipelines, operating frequencies, etc. An example of such heterogeneous processor cores may include what are known as “big.LITTLE” architectures in which slower, low-power processor cores may be coupled with more powerful and power-hungry processor cores. In similar aspects, an SoC (for example, SoC 12 of FIG. 1) may include any number of homogeneous or heterogeneous processors 14. In various aspects, not all off the processor cores 200, 201, 202, 203 need to be heterogeneous processor cores, as a heterogeneous processor may include any combination of processor cores 200, 201, 202, 203 including at least one heterogeneous processor core.

Each of the processor cores 200, 201, 202, 203 of a processor 14 may be designated a private processor core cache (PPCC) memory 210, 212, 214, 216 that may be dedicated for read and/or write access by a designated processor core 200, 201, 202, 203. The private processor core cache 210, 212, 214, 216 may store data and/or instructions, and make the stored data and/or instructions available to the processor cores 200, 201, 202, 203, to which the private processor core cache 210, 212, 214, 216 is dedicated, for use in execution by the processor cores 200, 201, 202, 203. The private processor core cache 210, 212, 214, 216 may include volatile memory as described herein with reference to memory 16 of FIG. 1.

Groups of the processor cores 200, 201, 202, 203 of a processor 14 may be designated a shared processor core cache (SPCC) memory 220, 222 that may be dedicated for read and/or write access by a designated group of processor core 200, 201, 202, 203. The shared processor core cache 220, 222 may store data and/or instructions, and make the stored data and/or instructions available to the group processor cores 200, 201, 202, 203 to which the shared processor core cache 220, 222 is dedicated, for use in execution by the processor cores 200, 201, 202, 203 in the designated group. The shared processor core cache 220, 222 may include volatile memory as described herein with reference to memory 16 of FIG. 1.

The processor 14 may be designated a shared processor cache memory 230 that may be dedicated for read and/or write access by the processor cores 200, 201, 202, 203 of the processor 14. The shared processor cache 230 may store data and/or instructions, and make the stored data and/or instructions available to the processor cores 200, 201, 202, 203, for use in execution by the processor cores 200, 201, 202, 203. The shared processor cache 230 may also function as a buffer for data and/or instructions input to and/or output from the processor 14. The shared cache 230 may include volatile memory as described herein with reference to memory 16 of FIG. 1.

Multiple processors 14 may be designated a shared system cache memory 240 that may be dedicated for read and/or write access by the processor cores 200, 201, 202, 203 of the multiple processors 14. The shared system cache 240 may store data and/or instructions, and make the stored data and/or instructions available to the processor cores 200, 201, 202, 203, for use in execution by the processor cores 200, 201, 202, 203. The shared system cache 240 may also function as a buffer for data and/or instructions input to and/or output from the multiple processors 14. The shared system cache 240 may include volatile memory as described herein with reference to memory 16 of FIG. 1.

In the example illustrated in FIG. 2, the processor 14 includes four processor cores 200, 201, 202, 203 (i.e., processor core 0, processor core 1, processor core 2, and processor core 3). In the example, each processor core 200, 201, 202, 203 is designated a respective private processor core cache 210, 212, 214, 216 (i.e., processor core 0 and private processor core cache 0, processor core 1 and private processor core cache 1, processor core 2 and private processor core cache 2, and processor core 3 and private processor core cache 3). The processor cores 200, 201, 202, 203 may be grouped, and each group may be designated a shared processor core cache 220, 222 (i.e., a group of processor core 0 and processor core 2 and shared processor core cache 0, and a group of processor core 1 and processor core 3 and shared processor core cache 1). For ease of explanation, the examples herein may refer to the four processor cores 200, 201, 202, 203, the four private processor core caches 210, 212, 214, 216, two groups of processor cores 200, 201, 202, 203, and the shared processor core cache 220, 222 illustrated in FIG. 2. However, the four processor cores 200, 201, 202, 203, the four private processor core caches 210, 212, 214, 216, two groups of processor cores 200, 201, 202, 203, and the shared processor core cache 220, 222 illustrated in FIG. 2 and described herein are merely provided as an example and in no way are meant to limit the various aspects to a four-core processor system with four designated private processor core caches and two designated shared processor core caches 220, 222. The computing device 10, the SoC 12, or the processor 14 may individually or in combination include fewer or more than the four processor cores 200, 201, 202, 203 and private processor core caches 210, 212, 214, 216, and two shared processor core caches 220, 222 illustrated and described herein.

In various aspects, a processor core 200, 201, 202, 203 may access data and/or instructions stored in the shared processor core cache 220, 222, the shared processor cache 230, and/or the shared system cache 240 indirectly through access to data and/or instructions loaded to a higher level cache memory from a lower level cache memory. For example, levels of the various cache memories 210, 212, 214, 216, 220, 222, 230, 240 in descending order from highest level cache memory to lowest level cache memory may be the private processor core cache 210, 212, 214, 216, the shared processor core cache 220, 222, the shared processor cache 230, and the shared system cache 240. In various aspects, data and/or instructions may be loaded to a cache memory 210, 212, 214, 216, 220, 222, 230, 240 from a lower level cache memory and/or other memory (e.g., memory 16, 24 in FIG. 1) as a response to a miss the cache memory 210, 212, 214, 216, 220, 222, 230, 240 for a memory access request, and/or as a response to a prefetch operation speculatively retrieving data and/or instructions for future use by the processor core 200, 201, 202, 203. In various aspects, the cache memory 210, 212, 214, 216, 220, 222, 230, 240 may be managed using an eviction policy to replace data and/or instructions stored in the cache memory 210, 212, 214, 216, 220, 222, 230, 240 to allow for storing other data and/or instructions. Evicting data and/or instructions may include writing the evicted data and/or instructions evicted from a higher level cache memory 210, 212, 214, 216, 220, 222, 230 to a lower level cache memory 220, 222, 230, 240 and/or other memory.

For ease of reference, the terms “hardware accelerator,” “custom hardware accelerator,” “multicore processor,” “processor,” and “processor core” may be used interchangeably herein. The descriptions herein of the illustrated computing device and its various components are only meant to be exemplary and in no way limiting. Several of the components of the illustrated example computing device may be variably configured, combined, and separated. Several of the components may be included in greater or fewer numbers, and may be located and connected differently within the SoC or separate from the SoC.

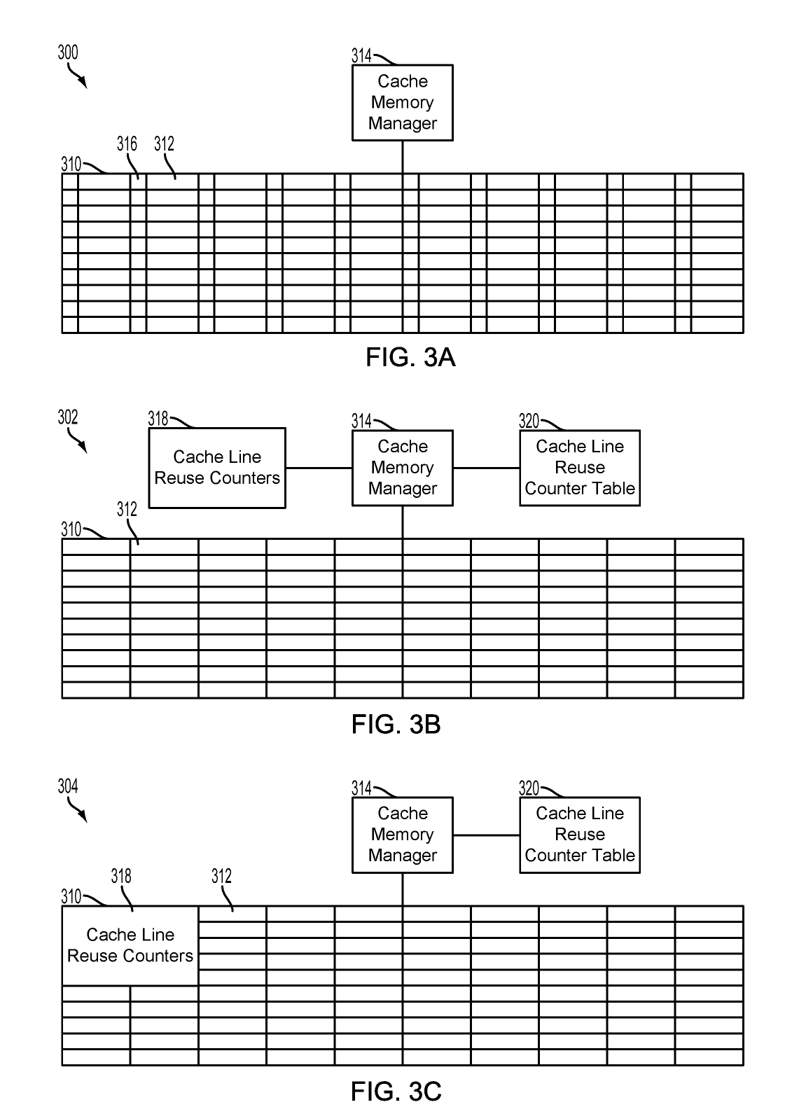

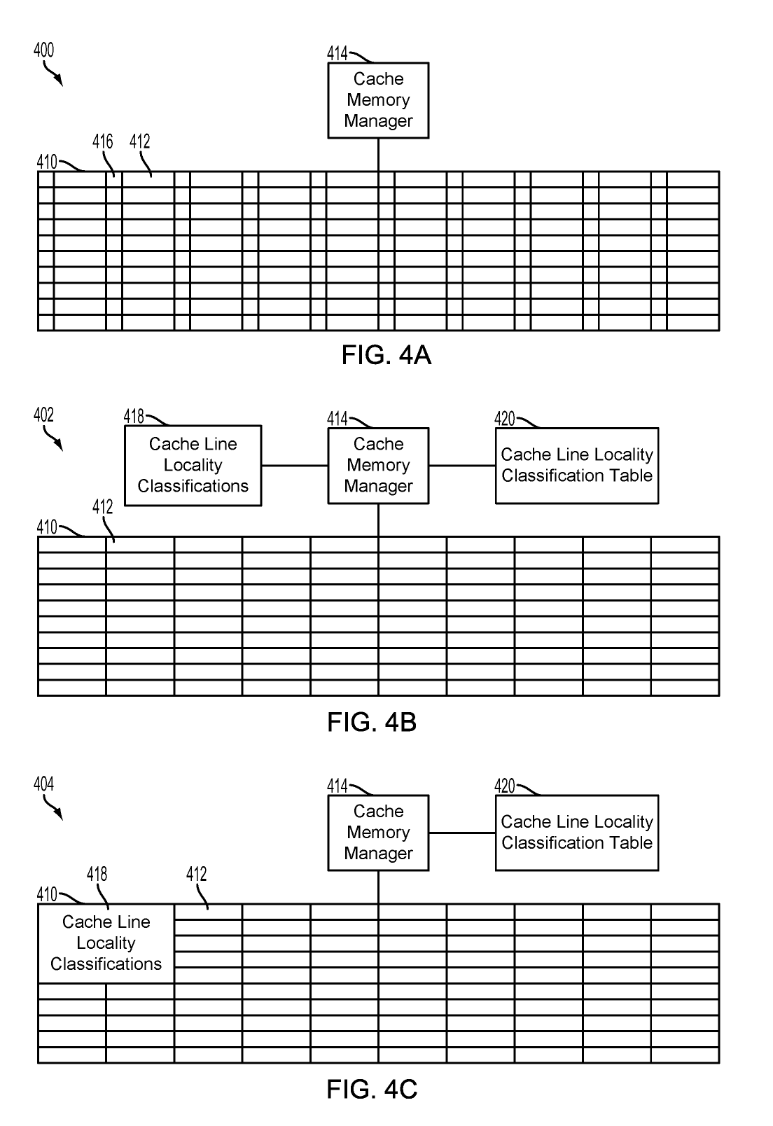

FIGS. 3A-3C illustrate an example higher level cache memory reuse aware system suitable for implementing various aspects. The examples in FIGS. 3A-3C illustrate various aspects of higher level cache memory reuse aware systems 300, 302, 304, each of which may include a higher level cache memory 310 (e.g., higher level cache memory 210, 212, 214, 216, 220, 222, 230 in FIG. 2; e.g., level 1 (L1) cache memory and/or level 2 (L2) cache memory), and a cache memory manager 314. The higher level cache memory 310 may be any cache memory of a higher level than a lower level cache memory (e.g., lower level cache memory 220, 222, 230, 240 in FIG. 2), including at least a last level cache memory, as described further herein with reference to FIGS. 4A-4C. The higher level cache memory 310 may be divided into any number of segments configured to store data and/or instructions of any size, such as a cache line 312, which may also be known as a cache block. The cache memory manager 314 may be communicatively connected to a processor (e.g., processor 14 in FIGS. 1 and 2) and the higher level cache memory 310, and configured to control access to the higher level cache memory 310 and to manage and maintain the higher level cache memory 310. The cache memory manager 314 may be configured to pass and/or deny memory access requests to the higher level cache memory 310 from the processor, pass data and/or instructions to and from the higher level cache memory 310, and/or trigger maintenance and/or coherency operations for the higher level cache memory 310, including an eviction policy.

FIG. 3A illustrates an example higher level cache memory reuse aware system 300 in which the higher level cache memory 310 includes a cache line reuse counter field 316 for each cache line 312 of the higher level cache memory 310. The reuse counter field 316 may store reuse counter data for an associated cache line 312. The reuse counter data may be configured to indicate a number of accesses to the cache line 312 between an insertion of data to the cache line 312 and an eviction of the data from the cache line 312, referred to herein as a reuse tracking period. In some aspect, the reuse counter data may be a cache line reuse counter datum of the number of accesses to the cache line 312 during the reuse tracking period. In various aspects, the data stored in the cache line 312 at a time of the eviction may not be identical to the data stored to the cache line 312 at a time of the insertion as the data may be operated on by the processor during the reuse tracking period.

In various aspects, the reuse counter field 316 may be configured to use any amount of space of a cache line 312, and the size of the reuse counter field 316 may be configured to store reuse counter data of a maximum expected value, which may indicate a maximum expected number of accesses between insertion and eviction of the data stored in the cache line 312. For example, the size of the reuse counter field 316 may be 2 bits of the cache line 312. As described further herein, the reuse counter datum may correspond to a locality classification for the data stored in the cache line 312, and a 2 bit reuse counter filed 316 may store four different values of reuse counter datum, which may correspond with up to four different locality classifications. In various aspects, any number of locality classifications may be used and may correspond to a single and/or a range of reuse counter datum values.

For each access to the cache line 312 during the reuse tracking period, the reuse counter datum may be updated. In various aspects, the update may modify the reuse counter datum according to any algorithm and/or operation. For example, the reuse counter datum may be configured as a sequential (i.e., incremental) counter increasing from a starting value of the reuse counter datum, such as a starting reuse counter datumvalue=0 (zero), and the reuse counter datum may be incremented by any integer value, such as an increment integer=1 (one), for each access to the cache line 312 during the reuse tracking period. In various aspects, the reuse counter datum in the reuse counter field 316 may be reset to the starting reuse counter value in response to an insertion of data to the cache line 312 and/or an eviction of data from the cache line 312. In various aspects, the cache memory manager 314 may be configured to update the reuse counter datum in the reuse counter field 316 in response to an access to the cache line 312 during the reuse tracking period and/or to reset the reuse cache datum in response to insertion and/or eviction of data to and/or from the cache line 312. In various aspects, the higher level cache memory 310 may include other hardware, such as a general purpose processor and/or a custom hardware controller, configured to update and/or reset the reuse counter datum in the reuse counter field 316.

FIGS. 3B and 3C illustrate an example higher level cache memory reuse aware systems 302, 304 in which cache line reuse counters 318 for each cache line 312 of the higher level cache memory 310 are separate from the cache lines 312. The example illustrated in FIG. 3B includes cache line reuse counters 318 that may be stored in a separate memory (e.g., memory 16, 24 in FIG. 1, lower level cache memory 220, 222, 230, 240 in FIG. 2) from the higher level cache memory 310. In various aspects, the memory storing the reuse counters 318 may be communicatively connected to and/or integral to the cache memory manager 314. The example illustrated in FIG. 3C includes cache line reuse counters 318 that may be stored in the higher level cache memory 310. Similar to the reuse counter field 316, the reuse counters 318 may store reuse counter datum for associated cache lines 312. The reuse counter datum for each individual associated cache line 312 may be configured to indicate a number of accesses to the associated cache line 312 within a reuse tracking period, which may be the time between an insertion of data to the associated cache line 312 and an eviction of the data from the associated cache line 312. In various aspects, the data stored in the associated cache line 312 at a time of the eviction may not be identical to the data stored to the associated cache line 312 at a time of the insertion as the data may be operated on by the processor during the reuse tracking period.

The higher level cache memory reuse aware system 302, 304 may also include a cache line reuse counter table 320, which may be configured to store associations between the reuse counter datum of the reuse counters 318 and the associated cache lines 312 in the higher level cache memory 310. In various aspects the reuse counter table 320 may be stored in a memory (e.g., memory 16, 24 in FIG. 1, lower level cache memory 220, 222, 230, 240 in FIG. 2) that is separate from the higher level cache memory 310.

In various aspects, the memory storing the reuse counters 318 and/or the reuse counter table 320 may be communicatively connected to and/or integral to the cache memory manager 314. In various aspects, the reuse counter table 320 may be stored in the higher level cache memory 310. In various aspects, the reuse counters 318 and the reuse counter table 320 may be stored in the same and/or separate memories. In various aspects, the reuse counters 318 and the reuse counter table 320 may be separate entities and/or combined entities. When implemented as separate entities, the reuse counter table 320 may associate a location of a reuse counter datum in the reuse counters 318 to a location for a cache line 312 in the higher level cache memory 310. When implemented as combined entities, the reuse counter table 320 may associate a reuse counter datum in the reuse counters 318 to a location for a cache line 312 in the higher level cache memory 310.

The reuse counters 318 may be configured to use any amount of space of the memory in which the reuse counters 318 are stored. The size of the reuse counters 318 may be configured to store a reuse counter datum of a maximum expected value, which may indicate a maximum expected number of accesses between insertion and eviction of the data stored in the associated cache line 312. For example, the size of a reuse counter 318 may be 2 bits. As described further herein, the reuse counter datum may correspond to a locality classification for the data stored in the associated cache line 312, and a 2 bit reuse counter 318 may store four different values for reuse counter datum, which may correspond with up to four different locality classifications. In various aspects, any number of locality classifications may be used and may correspond to a single and/or a range of reuse counter values.

For each access to the associate cache line 312 during the reuse tracking period, the reuse counter datum may be updated. In various aspects, the update may modify the reuse counter datum according to any algorithm and/or operation. For example, the reuse counter datum may be configured as a sequential counter increasing from a starting value of the reuse counter datum, such as a starting reuse counter datumvalue=0 (zero), and the reuse counter datum may be incremented by any integer value, such as an increment integer=1 (one), for each access to the associated cache line 312 during the reuse tracking period. In various aspects, the value in the reuse counter 318 may be reset to the starting reuse counter datumvalue in response to an insertion of data to the associated cache line 312 and/or an eviction of data from the associated cache line 312. In various aspects, the cache memory manager 314 may be configured to update the reuse counter datum in the reuse counter 318 in response to an access to the associated cache line 312 during the reuse tracking period and/or to reset the reuse cache datum in response to insertion and/or eviction of data to and/or from the associated cache line 312. In various aspects, the higher level cache memory 310 may include other hardware, such as a general purpose processor and/or a custom hardware controller, configured to update and/or reset the reuse counter datum in the reuse counter 318.

FIGS. 4A-4C illustrate an example last level cache memory reuse aware system suitable for implementing various aspects. The examples in FIGS. 4A-4C illustrate various aspects of last level cache memory reuse aware systems 400, 402, 404, each of which may include a last level cache memory 410 (e.g., lower level cache memory 220, 222, 230, 240 in FIG. 2; e.g., level 2 (L2) cache memory and/or level 3 (L3) cache memory), and a cache memory manager 414 (which may be the cache memory manager 314 in FIG. 3). The last level cache memory 410 may be any cache memory of a lower level than a higher level cache memory (e.g., higher level cache memory 210, 212, 214, 216, 220, 222, 230 in FIG. 2, higher level cache memory 310 in FIGS. 3A-3C). The last level cache memory 410 may be divided into any number of segments configured to store data and/or instructions of any size, such as a cache line 412, which may also be known as a cache block.

The cache memory manager 414 may be communicatively connected to a processor (e.g., processor 14 in FIGS. 1 and 2) and the last level cache memory 410, and configured to control access to the last level cache memory 410 and to manage and maintain the last level cache memory 410. The cache memory manager 414 may be configured to pass and/or deny memory access requests to the last level cache memory 410 from the processor, pass data and/or instructions to and from the last level cache memory 410, and/or trigger maintenance and/or coherency operations for the last level cache memory 410, including an eviction policy.

FIG. 4A illustrates an example last level cache memory reuse aware system 400 in which the last level cache memory 410 includes a cache line locality classification field 416 for each cache line 412 of the last level cache memory 410. The locality classification field 416 may store locality classification data for an associated cache line 412. In some aspect, the locality classification data may be a single value (i.e., locality classification datum). The locality classification datum may be configured to indicate a locality classification for data evicted from a cache line (e.g., cache line 312 in FIGS. 3A-3C) of a higher level cache memory and stored to a cache line 412 of the last level cache memory 410 based on the reuse counter datum of the evicted cache line. In various aspects, the reuse counter datum may be written to the locality classification field 416 as the locality classification datum. In various aspects, the reuse counter datum may be interpreted to a locality classification (as described further herein), and a locality classification value corresponding to the locality classification may be written to the locality classification field 416. In aspects in which the last level cache memory 410 is configured as inclusive mode cache memory, a default locality classification value may be written to the locality classification field 416 for a cache line 412 written from another memory (e.g., memory 16, 24 in FIG. 1), such as random access memory.

In various aspects, the locality classification field 416 may be configured to use any amount of space of a cache line 412, and the size of the locality classification field 416 may be configured to set a maximum number of locality classifications. For example, the size of the locality classification field 416 may be 2 bits of the cache line 412. The locality classification datum may correspond to a locality classification for the data stored in the cache line 412, and a 2 bit locality classification field 416 may store four different values of the locality classification datum, which may correspond with up to four different locality classifications (e.g., high locality, medium locality, low locality, very low/no locality). In various aspects, any number of locality classifications may be used and may correspond to a single and/or a range of reuse counter values.

The reuse counter datum may be interpreted as a locality classification according to any algorithm and/or operation. For example, the reuse counter datum may be compared to any number of locality classification thresholds to interpret which locality classification the reuse counter datum may correspond with. The number of locality classification thresholds may be one less than the number of locality classifications, such that each locality classification threshold represents a boundary value between locality classifications. For example, a locality classification threshold may include a value X. Comparing the reuse counter datum to the locality classification threshold value X may be used to determine the locality classification corresponding to the reuse counter datum. A reuse counter value greater than (or equal to) the locality classification threshold value may indicate that the reuse counter datum corresponds to a first locality classification, and a reuse counter datumvalue less than (or equal to) the locality classification threshold value may indicate that the reuse counter datum corresponds to a second locality classification. Further comparisons of the reuse counter datum value with other locality classification thresholds may further confirm and/or narrow the locality classification to which the reuse counter datum corresponds. The locality classification datum configured to indicate the locality classification to which the reuse counter datum corresponds may be written to the locality classification field 416.

In various aspects, other eviction policy data of the last level cache memory 410 may be updated based on writing the cache line 412 and/or the locality classification datum to the last level cache memory 410. In various aspects, the cache memory manager 414 may be configured to interpret the reuse counter datum and write the cache line 412 and the locality classification datum to the locality classification field 416 in the last level cache memory 410 in response to an eviction of a cache line from higher level cache memory and/or to insertion of a new cache line 412 in inclusive mode. In various aspects, the last level cache memory 410 may include other hardware, such as a general purpose processor and/or a custom hardware controller, configured to interpret the reuse counter datum and/or write the cache line 412 and the locality classification datum to the locality classification field 416.

FIGS. 4B and 4C illustrate example last level cache memory reuse aware systems 402, 404 in which cache line locality classification records 418 for each cache line 412 of the last level cache memory 410 are separate from the cache lines 412. The example illustrated in FIG. 4B includes cache line locality classification records 418 that may be stored in a separate memory (e.g., memory 16, 24 in FIG. 1, lower level cache memory 220, 222, 230, 240 in FIG. 2) from the last level cache memory 410. In various aspects, the memory storing the locality classification records 418 may be communicatively connected to and/or integral to the cache memory manager 414. The example illustrated in FIG. 3C includes cache locality classification records 418 that may be stored in the last level cache memory 410. Similar to the locality classifications field 416, the locality classification record 418 may store locality classification data for associated cache lines 412. The locality classification datum for each individual associated cache line 412 may be configured to indicate a locality classification for data evicted from a cache line of a higher level cache memory and stored to an associated cache line 412 of the last level cache memory 410 based on the reuse counter datum of the evicted cache line. In various aspects, the reuse counter datum may be written to the locality classification record 418 as the locality classification datum. In various aspects, the reuse counter datum may be interpreted to a locality classification, and a locality classification datum value corresponding to the locality classification may be written to the locality classification record 418. In aspects in which the last level cache memory 410 is configured as inclusive mode cache memory, a default locality classification datum value may be written to the locality classification record 418 for a cache line 412 written from another memory, such as random access memory.

The last level cache memory reuse aware system 402, 404 may also include a cache line locality classification table 420, which may be configured to store associations between the locality classification data of the locality classification records 418 and the associated cache lines 412 in the last level cache memory 410. In various aspects, the locality classification table 420 may be stored in a memory (e.g., memory 16, 24 in FIG. 1, lower level cache memory 220, 222, 230, 240 in FIG. 2) that is separate from the last level cache memory 410. In various aspects, the memory storing the locality classification records 418 and/or the locality classification table 420 may be communicatively connected to and/or integral to the cache memory manager 414. In various aspects, the locality classification table 420 may be stored in the last level cache memory 410. In various aspects, the locality classification records 418 and the locality classification table 420 may be stored in the same and/or separate memories.

In various aspects, the locality classification records 418 and the locality classification table 420 may be separate entities and/or combined entities. When implemented as separate entities the locality classification table 420 may associate a location of a locality classification datum in the locality classification records 418 to a location for a cache line 412 in the last level cache memory 410. When implemented as combined entities, the locality classification table 420 may associate a locality classification datum in the locality classification records 418 to a location for a cache line 412 in the last level cache memory 410.

The locality classification records 418 may be configured to use any amount of space, and the size of a locality classification record 418 may be configured to set a maximum number of locality classifications. For example, the size of the locality classification record 418 may be 2 bits. The locality classification datum value may correspond to a locality classification for the data stored in the associated cache line 412, and a 2 bit locality classification record 418 may store four different values of the locality classification datum, which may correspond with up to four different locality classifications (e.g., high locality, medium locality, low locality, very low/no locality). In various aspects, any number of locality classifications may be used and may correspond to a single and/or a range of reuse counter datum values.

The reuse counter datum may be interpreted as a locality classification according to any algorithm and/or operation. For example, the reuse counter datum may be compared to any number of locality classification thresholds to interpret which locality classification the reuse counter datum may correspond with. The number of locality classification thresholds may be one less than the number of locality classifications, such that each locality classification threshold represents a boundary value between locality classifications. For example, a locality classification threshold may include a value X. Comparing the reuse counter datum to the locality classification threshold value X may be used to determine the locality classification corresponding to the reuse counter datum. A reuse counter datum greater than (or equal to) the locality classification threshold value may indicate that the reuse counter datum corresponds to a first locality classification, and the reuse counter datum less than (or equal to) the locality classification threshold value may indicate that the reuse counter datum corresponds to a second locality classification. Further comparisons of the reuse counter datum with other locality classification thresholds may further confirm and/or narrow the locality classification to which the reuse counter datum corresponds. The locality classification datum configured to indicate the locality classification to which the reuse counter datum corresponds may be written to the locality classification records 418.

In various aspects, other eviction policy data of the last level cache memory 410 may be updated based on writing the associated cache line 412 and/or the locality classification datum to the last level cache memory 410. In various aspects, the cache memory manager 414 may be configured to interpret the reuse counter datum and write the associated cache line 412 in the last level cache memory 410 and the locality classification datum to the locality classification records 418 in response to an eviction of a cache line from higher level cache memory and/or to insertion of a new cache line 412 in inclusive mode. In various aspects, the last level cache memory 410 may include other hardware, such as a general purpose processor and/or a custom hardware controller, configured to interpret the reuse counter datum and/or write the cache line 412 and the locality classification datum to the locality classification records 418.

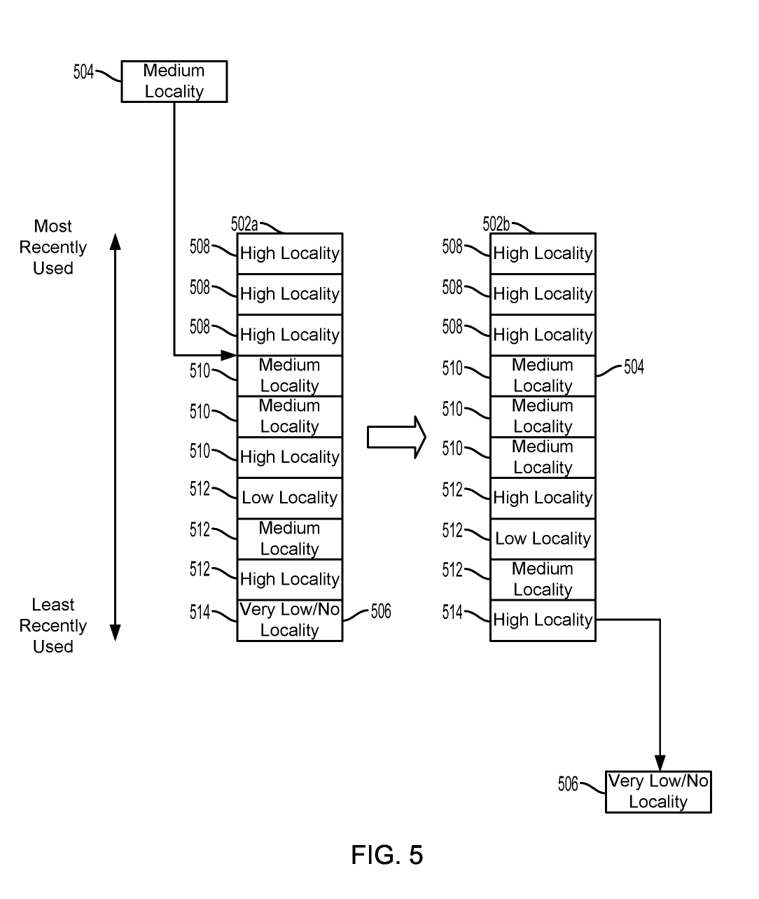

FIG. 5 illustrates an example last level cache memory eviction order according to an eviction policy combined with reuse aware cache line insertion and victim selection suitable for implementing various aspects. A last level cache memory (e.g., lower level cache memory 220, 222, 230, 240 in FIG. 2, last level cache 410 in FIGS. 4A-4C) may be managed by a cache memory manager (e.g., cache memory manager 414 in FIGS. 4A-4C) according to an eviction policy that is configured to select a cache line (e.g., cache line 412 in FIGS. FIGS. 4A-4C) in response to an insertion of another cache line evicted from a higher level cache memory (e.g., higher level cache memory 210, 212, 214, 216, 220, 222, 230 in FIG. 2, higher level cache memory 310 in FIGS. 3A-3C) or inserted from another memory (e.g., memory 16, 24 in FIG. 1), such as random access memory). The cache memory manager may manage an eviction order queue 502a, 502b in accordance with the eviction policy in combination with reuse aware cache line insertion and victim selection. In other words, the cache memory manager may combine the eviction policy and locality classifications of the cache lines in the last level cache memory to manage the eviction order queue 502a, 502b. For example, the eviction policy may dictate that a least recently used cache line 506 is evicted from the last level cache memory when space is needed for an incoming cache line 504. Where the incoming cache line 504 is inserted into the eviction order queue 502a, 502b, and how that insertion affects the eviction order queue 502a, 502b may be based on the locality classification of the incoming cache line 504.

FIG. 5 illustrates an example in which there are four locality classifications for the cache lines in the last level cache memory, high locality, medium locality, low locality, and very low/no locality. When cache lines are inserted into the last level cache memory, the locality classification of the inserted cache line may determine where in the eviction order queue 502a, 502b and/or the last level cache memory the inserted cache line is slotted. For purposes of brevity and ease of explanation, the following examples are described in terms of the eviction order queue 502a, 502b, but they are also applicable to the last level cache memory. For example, inserted cache lines with a high locality classification may be inserted in the most recently used position of the eviction order queue 502a, 502b. The eviction order queue 502a, 502b, and/or the last level cache memory, may include positions designated for high locality cache lines 508, such as the top position and/or any number of positions below the top position in the eviction order queue 502a, 502b. Inserted cache lines with a medium locality classification may be inserted at a position that is sooner to be evicted from the eviction order queue 502a, 502b than positions designated for the high locality cache lines 508. The eviction order queue 502a, 502b may include positions designated for insertion of medium locality cache lines 510 that are positions that are sooner to be evicted from the eviction order queue 502a, 502b than positions designated for the high locality cache lines 508. Inserted cache lines with a low locality classification may be inserted at a position that are sooner to be evicted from the eviction order queue 502a, 502b than positions designated for the medium locality cache lines 510. The eviction order queue 502a, 502b may include positions designated for insertion of low locality cache lines 512 that are positions that are sooner to be evicted from the eviction order queue 502a, 502b than positions designated for the medium locality cache lines 510. Inserted cache lines with a very low/no locality classification may be inserted at a position that are sooner to be evicted from the eviction order queue 502a, 502b than positions designated for the low locality cache lines 512. The eviction order queue 502a, 502b may include positions designated for insertion of very low/no locality cache lines 514 that are positions that are sooner to be evicted from the eviction order queue 502a, 502b than positions designated for low locality cache lines 512, such as a least recently used position of the eviction order queue 502a, 502b.

In the example in FIG. 5, a cache line 504 with medium locality, evicted from a higher level cache memory and/or to be inserted from another memory, may be inserted into the last level cache memory. The eviction order queue 502a, 502b may be updated by inserting the cache line 504 into a position 510 that is sooner to be evicted from the eviction order queue 502a, 502b than positions designated for the high locality cache lines 508. The cache line 504 may also be inserted into a position 510 that is later to be evicted from the eviction order queue 502a, 502b than positions designated for the low locality cache lines 512. The eviction order queue 502a, 502b may be updated by reordering the cache lines in the eviction order queue 502a, 502b to accommodate insertion of the cache line 504. For example, any of the cache lines in position sooner to be evicted from the eviction order queue 502a, 502b than the position 510 of the cache line 504 may be shifted down the eviction order queue 502a, 502b. Further, the cache line 506 in the least recently used position of the eviction order queue 502a, 502b may be evicted from the eviction order queue 502a, 502b and the last level cache. The cache line 506 may be written to another memory.

In various aspects, priority for eviction may be based on the locality classification of the cache lines. The priority for eviction may be inverse to the locality classification of the cache line. In other words, the higher the priority for eviction, the lower the locality for the cache line, and the lower the priority for eviction, the higher the locality for the cache line. In the example in FIG. 5, the cache lines that may be evicted from the last level cache may be selected from the eviction order queue 502a, 502b based on location in the eviction order queue 502a, 502b and priority for eviction/locality classification. The cache lines that may be evicted may be selected from any combination of positions 508, 510, 512, 514 in the eviction order queue 502a, 502b. For example, the cache lines that may be evicted may be selected from any of the positions 510, 512, 514 in the eviction order queue 502a, 502b that are not the most frequently used positions or positions designated for high locality cache lines 508. From among these positions 510, 512, 514, the cache line with the highest priority for eviction/lowest locality classification may be evicted. In the example in FIG. 5, the cache line with the highest priority for eviction/lowest locality classification is cache line 506 with a very low/no locality classification. Even though in this example the cache line 506 is at the least recently used position in the eviction order queue 502a, 502b, the cache line 506 would still be evicted from a position that indicates more recent use based on the highest priority/lowest locality classification of the cache line 506. For further example, a next cache line for eviction from the last level cache memory may be the low locality classified cache in position 512 based on its now highest priority/lowest locality classification of the cache line, even though it is not in the least recently used position in the eviction order queue 502a, 502b.

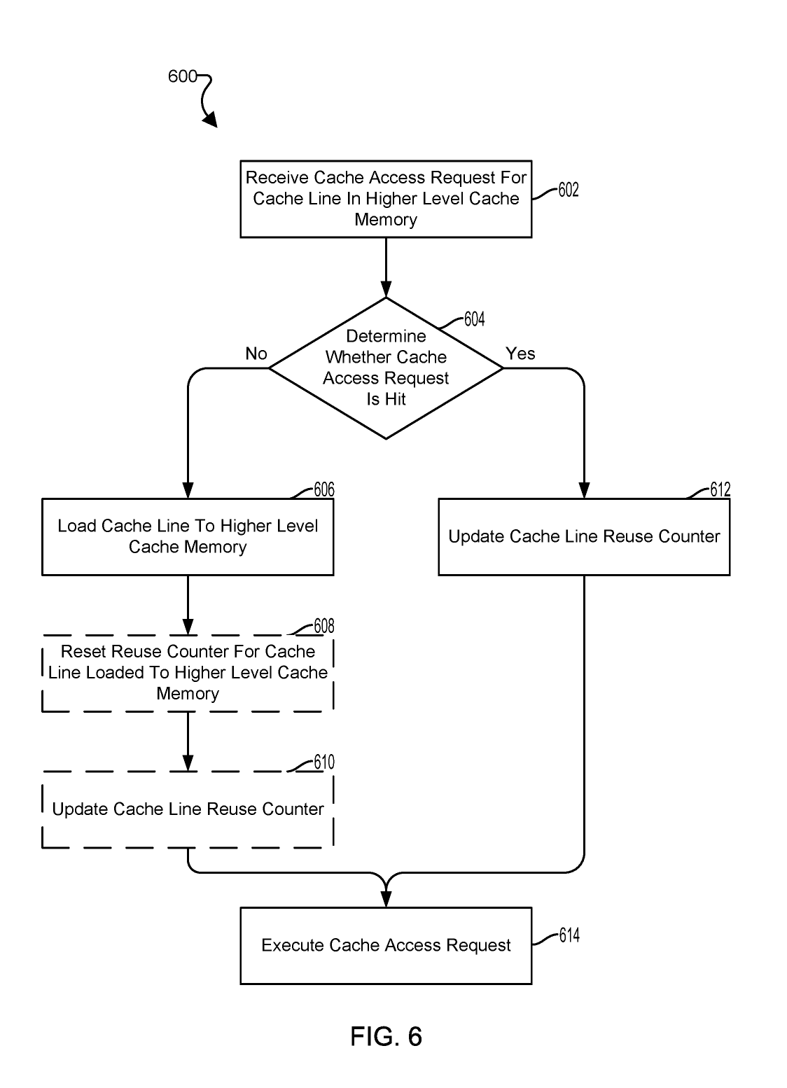

FIG. 6 illustrates a method 600 for implementing reuse tracking of a cache line in a higher level cache memory according to various aspects. The method 600 may be implemented in a computing device in software executing in a processor (e.g., the processor 14 in FIGS. 1 and 2), in general purpose hardware, in dedicated hardware (e.g., cache memory manager 314 in FIGS. 3A-3C, cache memory manager 414 in FIGS. 4A-4C), or in a combination of a software-configured processor and dedicated hardware, such as a processor executing software within a cache memory reuse aware system (e.g., higher level cache memory reuse aware system 300, 302, 304 in FIGS. 3A-3C, last level cache memory reuse aware systems 400, 402, 404 in FIGS. 4A-4C) that includes other individual components (e.g., memory 16, 24 in FIG. 1, higher level cache memory 310 in FIGS. FIGS. 3A-3C, last level cache memory 410 in FIGS. 4A-4C), and various memory/cache controllers. In order to encompass the alternative configurations enabled in various aspects, the hardware implementing the method 600 is referred to herein as a “processing device.”

In block 602, the processing device may receive a cache access request for a cache line in a higher level cache memory. A cache access request may include a read, write, load, and/or store operation request for a cache line of the higher level cache memory. In some aspects, the cache access request may be for access to a cache line of the higher level cache memory for data and/or instructions for implementing a function of an application executed by a computing device (e.g., computing device 10 in FIG. 1).

In determination block 604, the processing device may determine whether the cache access request is a hit for the cache line of the higher level cache memory. The processing device may snoop and/or attempt to retrieve the contents of the cache line specified by the cache access request. The processing device may determine whether the cache line contains the requested content. In response to determining the cache line specified by the cache access request contains the requested content, the processing device may determine that the cache access request results in a hit for the cache line in the higher level cache memory. In response to determining the cache line specified by the cache access request does not contain the requested content, the processing device may determine that the cache access request results in a miss for the cache line in the higher level cache memory.

In block 606, in response to determining that the cache access request is not a hit for the cache line of the higher level cache memory (i.e., determination block 604=“No”), the processing device may load the requested cache line to the higher level cache memory in block 606. The processing device may retrieve the requested cache line from a lower level cache or another memory, such as a random access memory, for loading the requested cache line to the higher level cache memory. The processing device may insert, or write, the retrieved cache line to the higher level cache memory.

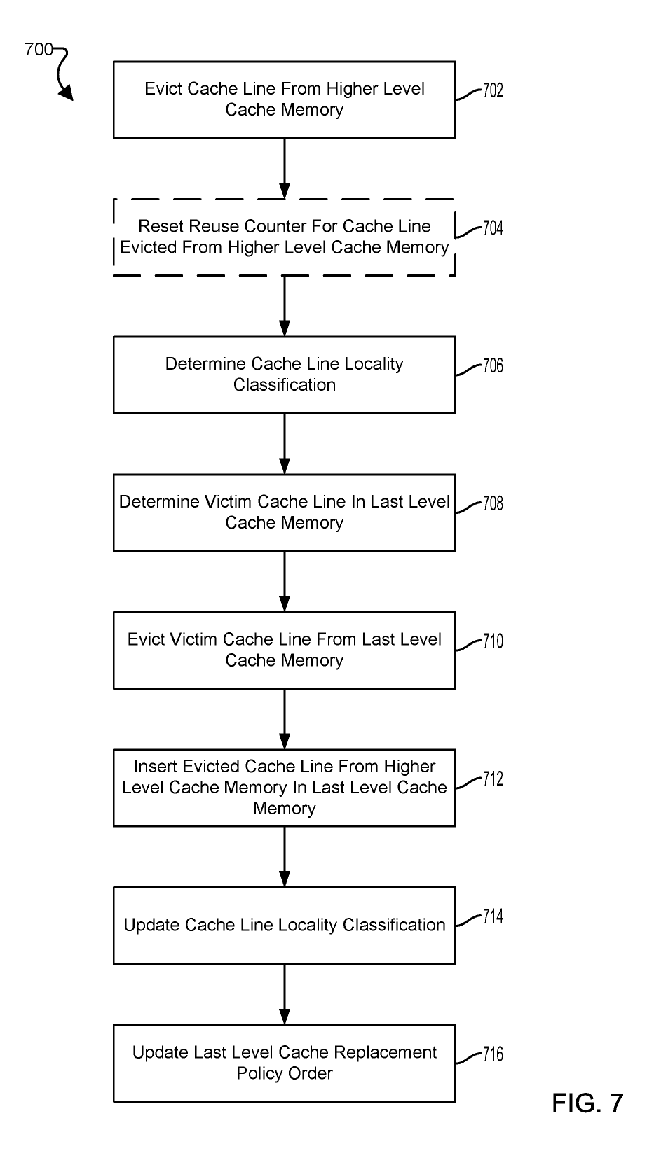

In optional block 604, the processing device may reset a cache line reuse counter for the cache line in the higher level cache memory. The cache line, for which the reuse counter may be reset, may be the cache line specified by the cache access request and to which the retrieved cache line is written. In various aspects, resetting the cache line reuse counter may include writing a default starting reuse counter datum value, such as a starting reuse counter datum value=0 (zero) and/or Null. In various aspects, the starting reuse counter datum value may be any value to be a beginning value from which a reuse counter may be updated in a manner indicating a number of times the cache line is accessed starting at and/or following insertion of the cache line in the higher level cache memory. As discussed further herein, there are other times at which the processing device may reset a cache line reuse counter for the cache line in the higher level cache memory, such as in optional block 704 of the method 700 described below with reference to FIG. 7.

In optional block 610, the processing device may update the cache line reuse counter for the cache line in the higher level cache memory. Updating the reuse counter for the cache line may indicate an access of the cache line in the higher level cache memory. The cache line being inserted into the higher level cache may make the cache line available for access in response to the cache access request. The reuse counter for the cache line inserted into the higher level cache memory may be updated in a manner so that the value of the reuse counter datum may indicate the access of the inserted cache line in response to the cache access request. The update to the reuse counter may be implemented via various algorithms and/or operations. For example, the reuse counter datum may be incremented by a predetermined value configured to indicate a single access to the cache line of the higher level cache memory. In various aspects, subsequent updates of the reuse counter may be configured to indicate cumulative accesses of the cache in during a reuse tracking period, such as between insertion of the cache line to the higher level cache memory and eviction of the cache line from the higher level cache memory.

In block 614, the processing device may execute the cache access request for the cache line in the higher level cache memory. In various aspects, executing the cache access request may include retrieving contents of the cache line and/or writing data and/or instruction content to the cache line. Regardless of the type of cache access request and how it may alter the contents of the cache line, the reuse counter for the cache line may be updated in optional block 610.

In response to determining that cache access request is a hit for the cache line of the higher level cache memory (i.e., determination block 604=“Yes”), processing device may updated the cache line reuse counter for the cache line in the higher level cache memory in block 612. Updating the reuse counter in block 612 may be accomplished in a manner similar to the description of updating the reuse counter in optional block 610.

In block 614, the processing device may execute the cache access request for the cache line in the higher level cache memory. Regardless of the type of cache access request and how it may alter the contents of the cache line, the reuse counter for the cache line may be updated in optional block 612.

FIG. 7 illustrates a method 700 for implementing reuse aware cache line insertion and victim selection in large cache memory according to some aspects. The method 700 may be implemented in a computing device in software executing in a processor (e.g., the processor 14 in FIGS. 1 and 2), in general purpose hardware, in dedicated hardware (e.g., cache memory manager 314 in FIGS. 3A-3C, cache memory manager 414 in FIGS. 4A-4C), or in a combination of a software-configured processor and dedicated hardware, such as a processor executing software within a cache memory reuse aware system (e.g., higher level cache memory reuse aware system 300, 302, 304 in FIGS. 3A-3C, last level cache memory reuse aware systems 400, 402, 404 in FIGS. 4A-4C) that includes other individual components (e.g., memory 16, 24 in FIG. 1, higher level cache memory 310 in FIGS. FIGS. 3A-3C, last level cache memory 410 in FIGS. 4A-4C), and various memory/cache controllers. In order to encompass the alternative configurations enabled in various aspects, the hardware implementing the method 700 is referred to herein as a “processing device.”

In block 702, the processing device may evict a cache line from the higher level cache memory. The cache line may be evicted based on an eviction policy configured to evict cache lines that are not accessed by a designated period, are not accessed at or above a designated frequency, or any other criteria for evicting a cache line from a higher level memory. In some aspects, in response to insertion of a new cache line into the higher level cache, a cache line may be selected for eviction based on such criteria and evicted to open space in the higher level cache memory to store the inserted cache line.

In optional block 704 the processing device may reset a cache line reuse counter for the cache line in the higher level cache memory. Resetting the reuse counter in optional block 704 may be accomplished in a manner similar to resetting the reuse counter in optional block 608 of the method 600 as described with reference to FIG. 6.

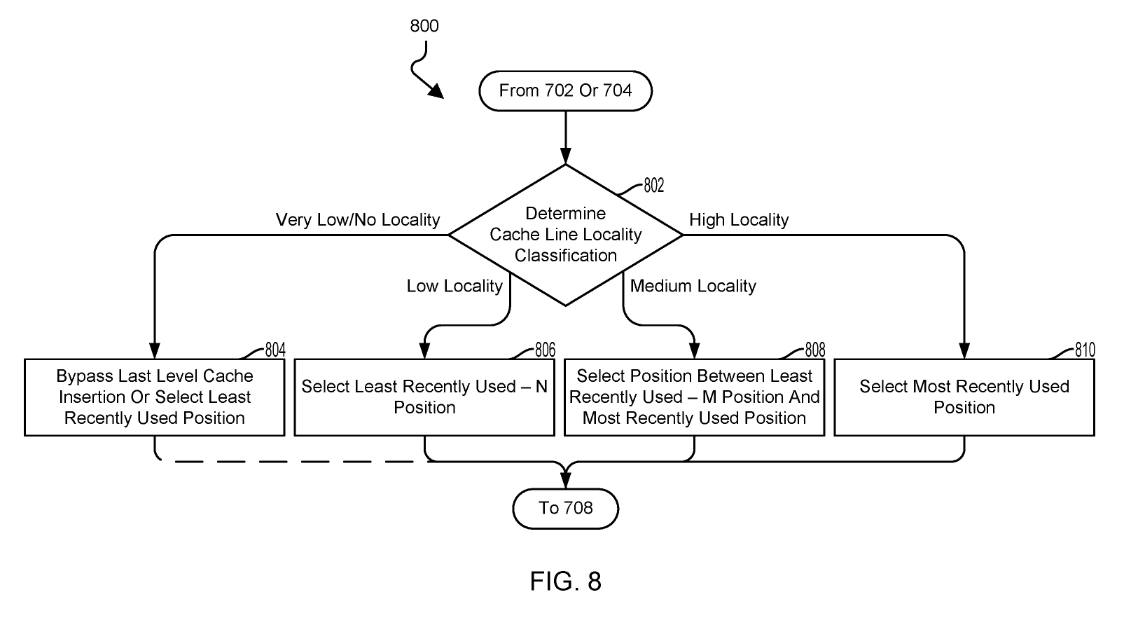

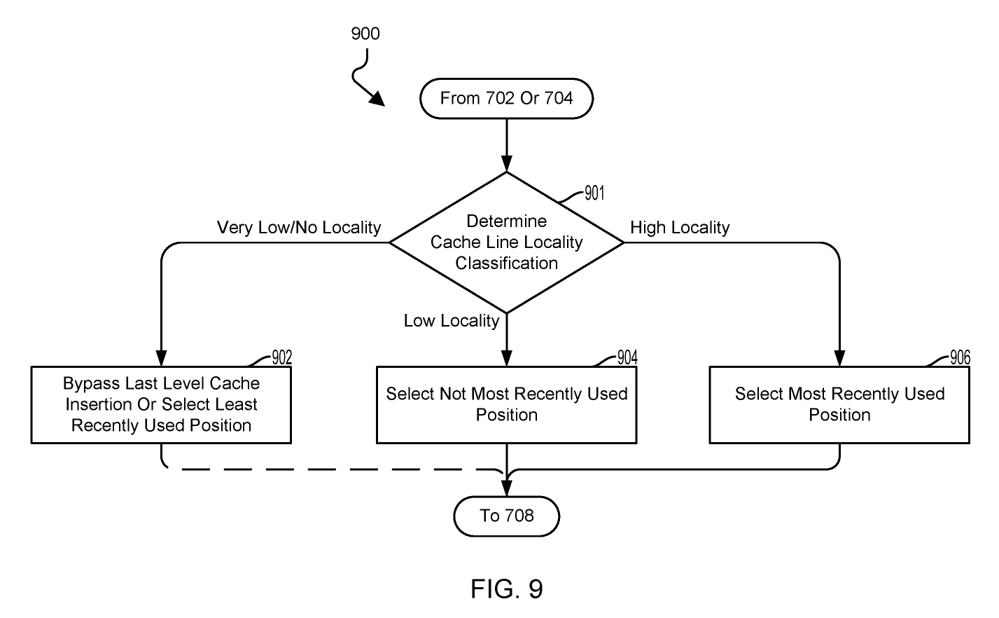

In block 706, the processing device may determine a cache line locality classification for the evicted cache line from the higher level cache memory. The evicted cache line may be associated with a cache line reuse counter of the higher level cache memory. The reuse counter datum may be used to determine a locality classification for the evicted cache line. The reuse counter datum may be compared to any number of locality classification thresholds which may each be configured to indicate a boundary for at least one locality classification. In various aspects, a number of locality classification thresholds may include one less locality classification threshold than a number of locality classifications. For example, four locality classifications may be separated by three locality classification thresholds, such as a locality classification threshold separating very low/no locality and low locality classifications, a locality classification threshold separating low locality and medium locality classifications, and a locality classification threshold separating medium locality and high locality classifications. A locality classification for a cache line may be determined by comparison of the reuse counter datum to at least one of the locality classification thresholds, the relationship of the reuse counter datum to the at least one locality classification threshold indicating the locality classification for the cache line. Further examples of determining a cache line locality classification for the evicted cache line from the higher level cache memory are described in the method 800 with reference to FIG. 8 and in the method 900 with reference to FIG. 9.

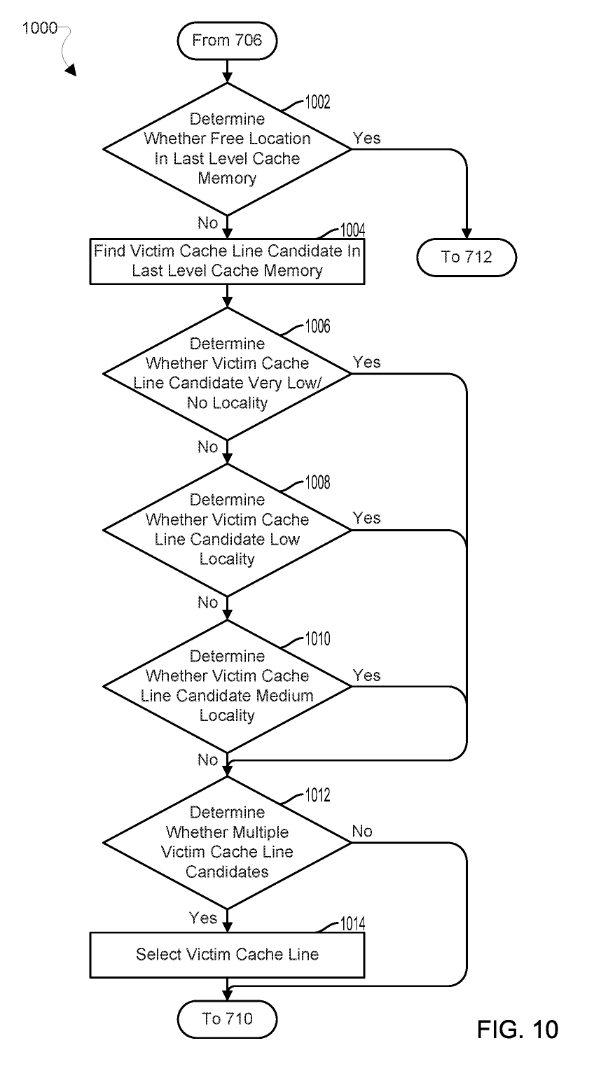

In block 708, the processing device may determine a victim cache line in the last level cache memory. A position of a cache line according to an eviction policy and/or a locality classification for the cache line may be used to determine which cache line in the last level cache memory may be the victim cache. The eviction policy and/or a locality classification may be used to determine an eligibility of a cache line to be the victim cache line and to select the victim cache line from among the eligible cache lines. The position of a cache line according to an eviction policy and/or a locality classification for the cache line may be determined by determining a cache line locality classification for the evicted cache line from the higher level cache memory, and is described in the method 800 with reference to FIG. 8 and in the method 900 with reference to FIG. 9. Determining a victim cache line in the last level cache memory is described in the method 1000 with reference to FIG. 10.

In block 710, the processing device may evict the victim cache line from the last level cache memory. The processing device may evict the victim cache line from the last level cache memory by writing the victim cache line to another memory (e.g., memory 16, 24 in FIG. 1), such as a random access memory. In various aspects, the processing device may invalidate the cache line in the last level cache memory, including any locality classification data in the cache line.

In block 712, the processing device may insert the evicted cache line from the higher level cache memory into the last level cache memory. The processing device may write the cache line to the last level cache memory to insert the evicted cache line from the higher level cache memory into the last level cache memory. In various aspects, the processing device may insert the evicted cache line from the higher level cache memory into the location of the last level cache memory from which the victim cache line is evicted from the last level cache memory. In various aspects, the processing device may insert the evicted cache line from the higher level cache memory into the location of the last level cache memory selected in response to determining a cache line locality classification for the evicted cache line from the higher level cache memory in block 706 and are described in the method 800 with reference to FIG. 8 and in the method 900 with reference to FIG. 9.

In block 714, the processing device may update the cache line locality classification for the cache line in the last level cache memory to which the evicted cache line from the higher level cache memory is inserted. The processing device may write a locality classification datum to a cache line locality classification field and/or record in and/or associated with the cache line in the last level cache memory to which the evicted cache line from the higher level cache memory is inserted. In various aspects, the processing device may overwrite the locality classification datum of the evicted victim cache line.

In block 716, the processing device may update a last level cache replacement policy order. In various aspects, an eviction order queue (e.g., eviction order queue 502a, 502b in FIG. 5) and/or locations in the last level cache memory may be designated for an order of evicting cache lines from the last level cache memory. As described herein, the positions in the eviction order queue and/or the last level cache memory (in various aspects, based on evicting a victim cache line), to which the evicted cache line from the higher level cache memory are inserted, may be updated to reflect changes based on victim cache line eviction and evicted cache line insertion. In various aspects, the cache lines may be reordered within the eviction order queue and/or in the last level cache memory so that the order for victim cache eviction from the last level cache memory according to the eviction policy is maintained. The processing device may shift and/or designation positions in the eviction order queue and/or in the last level cache memory to reflect changes in the order of eviction according to the eviction policy.

FIG. 8 illustrates a method 800 for implementing reuse aware cache line insertion with least recently used eviction protocol in large cache memory according to some aspects. The method 800 may be implemented in a computing device in software executing in a processor (e.g., the processor 14 in FIGS. 1 and 2), in general purpose hardware, in dedicated hardware (e.g., cache memory manager 314 in FIGS. 3A-3C, cache memory manager 414 in FIGS. 4A-4C), or in a combination of a software-configured processor and dedicated hardware, such as a processor executing software within a cache memory reuse aware system (e.g., higher level cache memory reuse aware system 300, 302, 304 in FIGS. 3A-3C, last level cache memory reuse aware systems 400, 402, 404 in FIGS. 4A-4C) that includes other individual components (e.g., memory 16, 24 in FIG. 1, higher level cache memory 310 in FIGS. FIGS. 3A-3C, last level cache memory 410 in FIGS. 4A-4C), and various memory/cache controllers. In order to encompass the alternative configurations enabled in various aspects, the hardware implementing the method 800 is referred to herein as a “processing device.” In various aspects, the method 800 may encompass operations performed in block 706 of the method 700 described with reference to FIG. 7 and/or be implemented as a standalone method.

In determination block 802, the processing device may determine a cache line locality classification for the evicted cache line from the higher level cache memory. As discussed herein, the processing device may compare the cache line reuse counter datum for the evicted cache line from the higher level cache memory with any number of locality classification thresholds to determine the locality classification for the evicted cache line. In various aspects, the processing device may compare the cache line reuse counter datum for the evicted cache line from the higher level cache memory to various locality classification thresholds in any order. The processing device may determine based on the relationship between the reuse counter datum for the evicted cache line from the higher level cache memory any of the locality classification thresholds to determine the locality classification for the evicted cache line. For example, for a reuse counter datum for the evicted cache line from the higher level cache memory less than (or equal to) a locality classification threshold between a lowest locality classification and a next lowest locality classification, the processing device may determine that the locality classification for the evicted cache line may be the lowest locality classification. For a reuse counter datum for the evicted cache line from the higher level cache memory greater than (or equal to) a locality classification threshold between a highest locality classification and a next highest locality classification, the processing device may determine that the locality classification for the evicted cache line may be the highest locality classification. For a reuse counter datum for the evicted cache line from the higher level cache memory between (or equal to one of) two locality classification thresholds separating a locality classification from two other locality classifications, the processing device may determine that the locality classification for the evicted cache line may be the locality classification between the two other locality classifications. In various aspects, there may be any number of locality classifications. In the method 800, for a last level cache memory configured to be managed by using a least recently used victim eviction policy, there may be a very low/no locality classification, a low locality classification, a medium locality classification, and a high locality classification.

In response to determining a very low/no locality classification for the evicted cache line from the higher level cache memory (i.e., determination block 802=“Very Low/No Locality”), the processing device may bypass the last level cache memory and/or select a least recently used position for the evicted cache line in block 804. In various aspects, the processing device may bypass the last level cache memory and write the evicted cache line from the higher level cache memory to another memory (e.g., memory 16, 24 in FIG. 1), such as a random access memory. In various aspects, the processing device may select a position in an eviction order queue and/or in the last level cache memory that is a position that is the soonest to be evicted according to the eviction criteria of the last level cache memory. In various aspects, the position may be a position of a group of positions that are the soonest to be evicted according to the eviction criteria of the last level cache memory. The position may be referred to as a least recently used position.

In response to determining a low locality classification for the evicted cache line from the higher level cache memory (i.e., determination block 802=“Low Locality”), the processing device may select a least recently used position—N position for the evicted cache line in block 806. In various aspects, N may be any number so that the selected position is between the least recently used position and a most recently used position—M position. In various aspects, the processing device may select a position in an eviction order queue and/or in the last level cache memory that is a position that is between the soonest to be evicted and the second to last to be evicted according to the eviction criteria of the last level cache memory. In various aspects, the position may be a position of a group of positions that are between the soonest to be evicted and the second to last to be evicted according to the eviction criteria of the last level cache memory. The position may be referred to as a least recently used position—N position.

In response to determining a medium locality classification for the evicted cache line from the higher level cache memory (i.e., determination block 802=“Medium Locality”), the processing device may select a most recently used position—M position for the evicted cache line in block 808. In various aspects, M may be any number so that the selected position is between the most recently used position and a least recently used position—N position. In various aspects, the processing device may select a position in an eviction order queue and/or in the last level cache memory that is a position that is between the last to be evicted and the second soonest to be evicted according to the eviction criteria of the last level cache memory. In various aspects, the position may be a position of a group of positions that are between the last to be evicted and the second soonest to be evicted according to the eviction criteria of the last level cache memory. The position may be referred to as a most recently used position—M position.

In response to determining a high locality classification for the evicted cache line from the higher level cache memory (i.e., determination block 802=“High Locality”), the processing device may select a most recently used position for the evicted cache line in block 810. In various aspects, the processing device may select a position in an eviction order queue and/or in the last level cache memory that is a position that is the last to be evicted according to the eviction criteria of the last level cache memory. In various aspects, the position may be a position of a group of positions that are the last to be evicted according to the eviction criteria of the last level cache memory. The position may be referred to as a most recently used position.

FIG. 9 illustrates a method 900 for implementing reuse aware cache line insertion with not most recently used eviction protocol in large cache memory according to some aspects. The method 900 may be implemented in a computing device in software executing in a processor (e.g., the processor 14 in FIGS. 1 and 2), in general purpose hardware, in dedicated hardware (e.g., cache memory manager 314 in FIGS. 3A-3C, cache memory manager 414 in FIGS. 4A-4C), or in a combination of a software-configured processor and dedicated hardware, such as a processor executing software within a cache memory reuse aware system (e.g., higher level cache memory reuse aware system 300, 302, 304 in FIGS. 3A-3C, last level cache memory reuse aware systems 400, 402, 404 in FIGS. 4A-4C) that includes other individual components (e.g., memory 16, 24 in FIG. 1, higher level cache memory 310 in FIGS. FIGS. 3A-3C, last level cache memory 410 in FIGS. 4A-4C), and various memory/cache controllers. In order to encompass the alternative configurations enabled in various aspects, the hardware implementing the method 900 is referred to herein as a “processing device.” In various aspects, the method 900 may encompass operations performed in block 706 of the method 700 described with reference to FIG. 7 and/or be implemented as a standalone method.

In determination block 901, the processing device may determine a cache line locality classification for the evicted cache line from the higher level cache memory. The processing device may determine a cache line locality classification for the evicted cache line from the higher level cache memory in a manner similar to the description of determination block 802 of the method 800 (FIG. 8). In the method 900, for a last level cache memory configured to be managed by using a not most recently used victim eviction policy, there may be a very low/no locality classification, low locality classification, and a high locality classification.

In response to determining a very low/no locality classification for the evicted cache line from the higher level cache memory (i.e., determination block 901=“Very Low/No Locality”), the processing device may bypass the last level cache memory and/or select a least recently used position for the evicted cache line in block 902. In various aspects, the processing device may bypass the last level cache memory and write the evicted cache line from the higher level cache memory to another memory (e.g., memory 16, 24 in FIG. 1), such as a random access memory. In various aspects, the processing device may select a position in an eviction order queue and/or in the last level cache memory that is a position that is the soonest to be evicted according to the eviction criteria of the last level cache memory. In various aspects, the position may be a position of a group of positions that are the soonest to be evicted according to the eviction criteria of the last level cache memory. The position may be referred to as a least recently used position.

In response to determining a low locality classification for the evicted cache line from the higher level cache memory (i.e., determination block 901=“Low Locality”), the processing device may select a not most recently used position for the evicted cache line in block 904. In various aspects, the processing device may select a position in an eviction order queue and/or in the last level cache memory that is a position that is not the last to be evicted according to the eviction criteria of the last level cache memory. In various aspects, the position may be a position of a group of positions that are not the last to be evicted according to the eviction criteria of the last level cache memory. In various aspects, the processing device may select a position in an eviction order queue and/or in the last level cache memory that is a position that is between the soonest to be evicted and the last to be evicted according to the eviction criteria of the last level cache memory. In various aspects, the position may be a position of a group of positions that are between the soonest to be evicted and the last to be evicted according to the eviction criteria of the last level cache memory. The position may be referred to as a not recently used position.

In response to determining a high locality classification for the evicted cache line from the higher level cache memory (i.e., determination block 901=“High Locality”), the processing device may select a most recently used position for the evicted cache line in block 906. In various aspects, the processing device may select a position in an eviction order queue and/or in the last level cache memory that is a position that is the last to be evicted according to the eviction criteria of the last level cache memory. In various aspects, the position may be a position of a group of positions that are the last to be evicted according to the eviction criteria of the last level cache memory. The position may be referred to as a most recently used position.

FIG. 10 illustrates a method 1000 for implementing reuse aware cache line victim selection in large cache memory cache memory according to an aspect. The method 1000 may be implemented in a computing device in software executing in a processor (e.g., the processor 14 in FIGS. 1 and 2), in general purpose hardware, in dedicated hardware (e.g., cache memory manager 314 in FIGS. 3A-3C, cache memory manager 414 in FIGS. 4A-4C), or in a combination of a software-configured processor and dedicated hardware, such as a processor executing software within a cache memory reuse aware system (e.g., higher level cache memory reuse aware system 300, 302, 304 in FIGS. 3A-3C, last level cache memory reuse aware systems 400, 402, 404 in FIGS. 4A-4C) that includes other individual components (e.g., memory 16, 24 in FIG. 1, higher level cache memory 310 in FIGS. FIGS. 3A-3C, last level cache memory 410 in FIGS. 4A-4C), and various memory/cache controllers. In order to encompass the alternative configurations enabled in various aspects, the hardware implementing the method 1000 is referred to herein as a “processing device.” In various aspects, the method 1000 may encompass operations performed in block 708 of the method 700 described with reference to FIG. 7 and/or be implemented as a standalone method.

In determination block 1002, the processing device may determine whether there is a free location in the last level cache memory. The processing device may check a record of free, invalid, and/or occupied locations in the last level cache memory to determine whether there is a free location in the last level cache memory. In various aspects, the processing device may use a free and/or invalid location in the last level cache memory as a free location in the last level cache memory.

In response to determining that there is a free location in the last level cache memory (i.e., determination block 1002=“Yes”), the processing device may insert the evicted cache line from the higher level cache memory into the last level cache memory in block 712 of the method 700 (FIG. 7).

In response to determining that there is not a free location in the last level cache memory (i.e., determination block 1002=“No”), the processing device may find a victim cache line candidate in the last level cache memory in block 1004. In various aspects, finding a victim cache line candidate in the last level cache memory may include determining positions from the eviction order queue and/or in the last level cache memory that may be associated with cache lines that may be evicted from the last level cache memory according to the eviction policy. As described herein, any position and/or combination of positions may be associated with cache lines eligible for eviction according to an eviction policy. In various aspects, such combinations of positions may exclude the most recently used positions, or include the not most recently used positions.

In determination block 1006, the processing device may determine whether a victim cache line candidate has a very low/no locality classification. The processing device may read the cache line locality classification datum for the victim cache line candidate to determine the locality classification for the victim cache line candidate. Victim cache line candidates having very low/no locality classification may be checked before victim cache line candidates having other locality classifications to prioritize eviction of the very low/no locality classification victim cache line candidates over other victim cache line candidates.

In response to determining that the victim cache line candidate has a very low/no locality classification (i.e., determination block 1006=“Yes”), the processing device may determine whether there are multiple victim cache line candidates with the same locality classification, in this instance very low/no locality classification, in determination block 1012.

In response to determining that the victim cache line candidate does not have a very low/no locality classification (i.e., determination block 1006=“No”), the processing device may determine whether a victim cache line candidate has a low locality classification in determination block 1008. The processing device may read the cache line locality classification datum for the victim cache line candidate to determine the locality classification for the victim cache line candidate. Victim cache line candidates having low locality classification may be checked before victim cache line candidates having other locality classifications, other than very low/no locality, to prioritize eviction of the low locality classification victim cache line candidates over the remaining other victim cache line candidates.

In response to determining that the victim cache line candidate has a low locality classification (i.e., determination block 1008=“Yes”), the processing device may determine whether there are multiple victim cache line candidates with the same locality classification, in this instance low locality classification, in determination block 1012.

In response to determining that the victim cache line candidate does not have a low locality classification (i.e., determination block 1008=“No”), the processing device may determine whether a victim cache line candidate has a medium locality classification in determination block 1010. The processing device may read the cache line locality classification datum for the victim cache line candidate to determine the locality classification for the victim cache line candidate. Victim cache line candidates having medium locality classification may be checked before victim cache line candidates having other locality classifications, other than very low/no locality and/or low locality, to prioritize eviction of the medium locality classification victim cache line candidates over the remaining other victim cache line candidates.

In response to determining that the victim cache line candidate has a medium locality classification (i.e., determination block 1010=“Yes”), the processing device may determine whether there are multiple victim cache line candidates with the same locality classification, in this instance medium locality classification, in determination block 1012.

In response to determining that the victim cache line candidate does not have a medium locality classification (i.e., determination block 1010=“No”), the processing device may determine whether there are multiple victim cache line candidates with the same locality classification, in this instance high locality classification, in determination block 1012.

In determination block 1012, the processing device may determine whether there are multiple victim cache line candidates with the same locality classification. In various aspects, the processing device may reduce the number of locality classifications that the processing device may consider to make the determination whether there are multiple victim cache line candidates. As discussed, the processing device may determine whether there are multiple victim cache line candidates with very low/no locality classification in response to determining that a victim cache line candidate has a very low/no locality classification (i.e., determination block 1006=“Yes”). The processing device may determine whether there are multiple victim cache line candidates with low locality classification in response to determining that a victim cache line candidate has a low locality classification (i.e., determination block 1008=“Yes”). The processing device may determine whether there are multiple victim cache line candidates with medium locality classification in response to determining that a victim cache line candidate has a medium locality classification (i.e., determination block 1010=“Yes”). The processing device may determine whether there are multiple victim cache line candidates with high locality classification in response to determining that a victim cache line candidate does not have a medium locality classification (i.e., determination block 1010=“No”). In making these determinations, processing device may read the locality classification datum of the remaining victim cache line candidates identified in block 1004 to determine the locality classification of the remaining victim cache line candidates, and compare the locality classification of the remaining victim cache line candidates to the appropriate locality classification to determine whether they match the appropriate locality classification.

In response to determining that there are multiple victim cache line candidates (i.e., determination block 1012=“Yes”), the processing device may evict the victim cache line from the last level cache memory in block 710 of the method 700 as described with reference to FIG. 7.

In response to determining that there are multiple victim cache line candidates (i.e., determination block 1012=“Yes”), the processing device may select a victim cache line from the multiple victim cache line candidates with the same locality classification in block 1014. In various aspects, the processing device may select a victim cache line from the multiple victim cache line candidates by applying the eviction criteria for the last level cache memory to the set of the multiple victim cache line candidates. After selecting the victim cache line, the processing device may evict the victim cache line from the last level cache memory in block 710 of the method 700 as described with reference to FIG. 7.

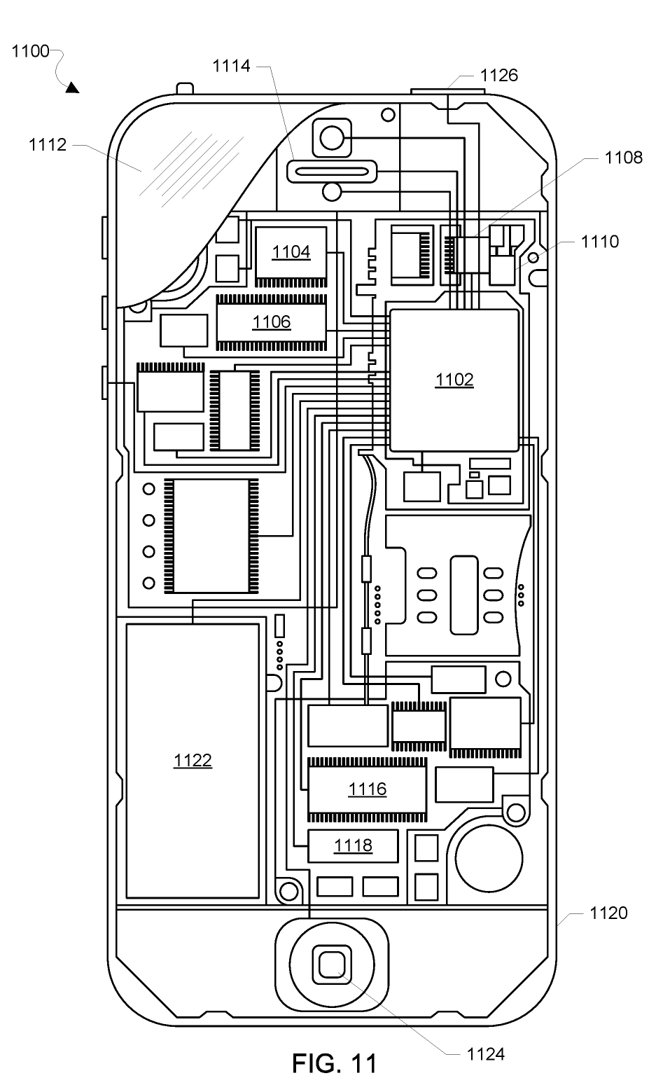

The various aspects (including, but not limited to, aspects described above with reference to FIGS. 1-10) may be implemented in a wide variety of computing systems including mobile computing devices, an example of which suitable for use with the various aspects is illustrated in FIG. 11. The mobile computing device 1100 may include a processor 1102 coupled to a touchscreen controller 1104 and an internal memory 1106. The processor 1102 may be one or more multicore integrated circuits designated for general or specific processing tasks. The internal memory 1106 may be volatile or non-volatile memory, and may also be secure and/or encrypted memory, or unsecure and/or unencrypted memory, or any combination thereof. Examples of memory types that can be leveraged include but are not limited to DDR, LPDDR, GDDR, WIDEIO, RAM, SRAM, DRAM, P-RAM, R-RAM, M-RAM, STT-RAM, and embedded DRAM. The touchscreen controller 1104 and the processor 1102 may also be coupled to a touchscreen panel 1112, such as a resistive-sensing touchscreen, capacitive-sensing touchscreen, infrared sensing touchscreen, etc. Additionally, the display of the computing device 1100 need not have touch screen capability.

The mobile computing device 1100 may have one or more radio signal transceivers 1108 (e.g., Peanut, Bluetooth, ZigBee, Wi-Fi, RF radio) and antennae 1110, for sending and receiving communications, coupled to each other and/or to the processor 1102. The transceivers 1108 and antennae 1110 may be used with the above-mentioned circuitry to implement the various wireless transmission protocol stacks and interfaces. The mobile computing device 1100 may include a cellular network wireless modem chip 1116 that enables communication via a cellular network and is coupled to the processor.

The mobile computing device 1100 may include a peripheral device connection interface 1118 coupled to the processor 1102. The peripheral device connection interface 1118 may be singularly configured to accept one type of connection, or may be configured to accept various types of physical and communication connections, common or proprietary, such as Universal Serial Bus (USB), FireWire, Thunderbolt, or PCIe. The peripheral device connection interface 1118 may also be coupled to a similarly configured peripheral device connection port (not shown).

The mobile computing device 1100 may also include speakers 1114 for providing audio outputs. The mobile computing device 1100 may also include a housing 1120, constructed of a plastic, metal, or a combination of materials, for containing all or some of the components described herein. The mobile computing device 1100 may include a power source 1122 coupled to the processor 1102, such as a disposable or rechargeable battery. The rechargeable battery may also be coupled to the peripheral device connection port to receive a charging current from a source external to the mobile computing device 1100. The mobile computing device 1100 may also include a physical button 1124 for receiving user inputs. The mobile computing device 1100 may also include a power button 1126 for turning the mobile computing device 1100 on and off.

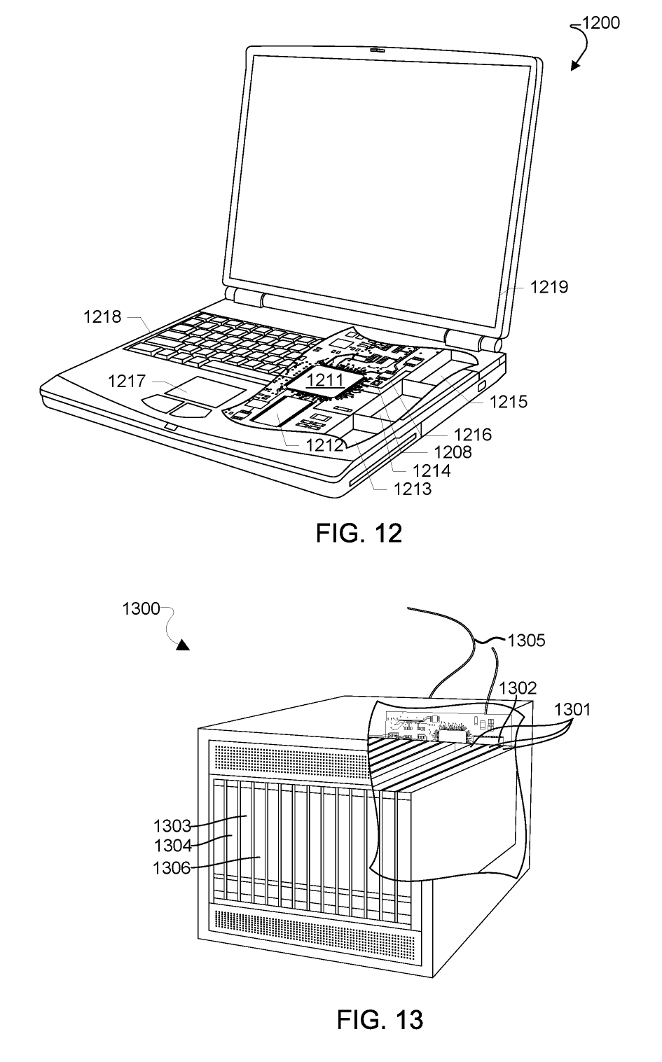

The various aspects (including, but not limited to, aspects described above with reference to FIGS. 1-10) may be implemented in a wide variety of computing systems include a laptop computer 1200 an example of which is illustrated in FIG. 12. Many laptop computers include a touchpad touch surface 1217 that serves as the computer's pointing device, and thus may receive drag, scroll, and flick gestures similar to those implemented on computing devices equipped with a touch screen display and described above. A laptop computer 1200 will typically include a processor 1211 coupled to volatile memory 1212 and a large capacity nonvolatile memory, such as a disk drive 1213 of Flash memory. Additionally, the computer 1200 may have one or more antenna 1208 for sending and receiving electromagnetic radiation that may be connected to a wireless data link and/or cellular telephone transceiver 1216 coupled to the processor 1211. The computer 1200 may also include a floppy disc drive 1214 and a compact disc (CD) drive 1215 coupled to the processor 1211. In a notebook configuration, the computer housing includes the touchpad 1217, the keyboard 1218, and the display 1219 all coupled to the processor 1211. Other configurations of the computing device may include a computer mouse or trackball coupled to the processor (e.g., via a USB input) as are well known, which may also be used in conjunction with the various aspects.

The various aspects (including, but not limited to, aspects described above with reference to FIGS. 1-10) may also be implemented in fixed computing systems, such as any of a variety of commercially available servers. An example server 1300 is illustrated in FIG. 13. Such a server 1300 typically includes one or more multicore processor assemblies 1301 coupled to volatile memory 1302 and a large capacity nonvolatile memory, such as a disk drive 1304. As illustrated in FIG. 13, multicore processor assemblies 1301 may be added to the server 1300 by inserting them into the racks of the assembly. The server 1300 may also include a floppy disc drive, compact disc (CD) or digital versatile disc (DVD) disc drive 1306 coupled to the processor 1301. The server 1300 may also include network access ports 1303 coupled to the multicore processor assemblies 1301 for establishing network interface connections with a network 1305, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

Computer program code or “program code” for execution on a programmable processor for carrying out operations of the various aspects may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

The foregoing method descriptions and the process flow diagrams are provided merely as illustrative examples and are not intended to require or imply that the operations of the various aspects must be performed in the order presented. As will be appreciated by one of skill in the art the order of operations in the foregoing aspects may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various aspects may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the aspects disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed aspects is provided to enable any person skilled in the art to make or use the claims. Various modifications to these aspects will be readily apparent to those skilled in the art, and the generic principles defined herein may be applied to other aspects and implementations without departing from the scope of the claims. Thus, the present disclosure is not intended to be limited to the aspects and implementations described herein, but is to be accorded the widest scope consistent with the following claims and the principles and novel features disclosed herein.

What is claimed is:

1. A method of implementing reuse aware cache line insertion and victim selection in large cache memory on a computing device, comprising:
receiving a cache access request for a cache line in a higher level cache memory;
updating a cache line reuse counter datum configured to indicate a number of accesses to the cache line in the higher level cache memory during a reuse tracking period in response to receiving the cache access request;
evicting the cache line from the higher level cache memory;
determining a cache line locality classification for the evicted cache line based on the cache line reuse counter datum;
inserting the evicted cache line into a last level cache memory; and
updating a cache line locality classification datum for the inserted cache line.

2. The method of claim 1, wherein updating a cache line reuse counter datum configured to indicate a number of accesses to the cache line during a reuse tracking period in response to receiving the cache access request comprises updating the cache line reuse counter datum in a cache line reuse counter field in the cache line in the higher level cache memory.

3. The method of claim 1, wherein:
inserting the evicted cache line into a last level cache memory comprises inserting the evicted cache line into a cache line in the last level cache memory; and
updating a cache line locality classification datum for the inserted cache line comprises updating the cache line locality classification datum in a cache line locality classification field in the cache line in the last level cache memory.

4. The method of claim 1, wherein determining a cache line locality classification for the evicted cache line based on the cache line reuse counter datum comprises comparing the cache line reuse counter datum to a locality classification threshold,
the method further comprising selecting a position corresponding to the cache line locality classification in an eviction order of an eviction policy for the last level cache memory.

5. The method of claim 4, wherein selecting a position corresponding to the cache line locality classification in an eviction order of an eviction policy for the last level cache memory comprises:
selecting a first position configured to be evicted prior to a second position in response to determining the cache line locality classification for the evicted cache line is a first cache line locality classification, wherein the first cache line locality classification is configured to indicate cache line locality less than a second cache line locality classification; and
selecting the second position in response to determining the cache line locality classification for the evicted cache line is the second cache line locality classification.

6. The method of claim 1, further comprising:
determining a victim cache line of the last level cache memory based on a locality classification datum of the victim cache line; and
evicting the victim cache line from the last level cache memory,
wherein:
inserting the evicted cache line into a last level cache memory comprises inserting the evicted cache line into a cache line in the last level cache memory vacated by evicting the victim cache line from the last level cache memory; and
updating a cache line locality classification datum for the inserted cache line comprises updating the cache line locality classification datum in a cache line locality classification field in the in the cache line in the last level cache memory.

7. The method of claim 6, wherein determining a victim cache line of the last level cache memory based on a locality classification datum of the victim cache line comprises determining whether a victim cache line candidate has a first locality classification,
the method further comprising determining whether the victim cache line candidate has a second locality classification in response to determining that the victim cache line does not have a first locality classification.

8. The method of claim 6, wherein determining a victim cache line of the last level cache memory based on a locality classification datum of the victim cache line comprises determining whether a victim cache line candidate has a first locality classification,
the method further comprising:
determining whether multiple victim cache line candidates have the first locality classification in response to determining that the victim cache line candidate has the first locality classification; and
selecting the victim cache line from the multiple victim cache line candidates based on a position in an eviction order of an eviction policy for the last level cache memory in response to determining that the multiple victim cache line candidates have the first locality classification.

9. A computing device, comprising:
a processor;
a higher level cache memory;
a last level cache memory; and
a cache memory manager communicatively connected to the processor, the higher level cache memory, and the last level cache memory, and configured to perform operations comprising:
receiving a cache access request for a cache line in the higher level cache memory;
updating a cache line reuse counter datum configured to indicate a number of accesses to the cache line in the higher level cache memory during a reuse tracking period in response to receiving the cache access request;
evicting the cache line from the higher level cache memory;
determining a cache line locality classification for the evicted cache line based on the cache line reuse counter datum;
inserting the evicted cache line into the last level cache memory; and
updating a cache line locality classification datum for the inserted cache line.

10. The computing device of claim 9, wherein the cache memory manager is configured to perform operations such that updating a cache line reuse counter datum configured to indicate a number of accesses to the cache line during a reuse tracking period in response to receiving the cache access request comprises updating the cache line reuse counter datum in a cache line reuse counter field in the cache line in the higher level cache memory.

11. The computing device of claim 9, wherein the cache memory manager is configured to perform operations such that:
inserting the evicted cache line into the last level cache memory comprises inserting the evicted cache line into a cache line in the last level cache memory; and
updating a cache line locality classification datum for the inserted cache line comprises updating the cache line locality classification datum in a cache line locality classification field in the cache line in the last level cache memory.

12. The computing device of claim 9, wherein:
the cache memory manager is configured to perform operations such that determining a cache line locality classification for the evicted cache line based on the cache line reuse counter datum comprises comparing the cache line reuse counter datum to a locality classification threshold; and
the cache memory manager is configured to perform operations comprising selecting a position corresponding to the cache line locality classification in an eviction order of an eviction policy for the last level cache memory.

13. The computing device of claim 12, wherein the cache memory manager is configured to perform operations such that selecting a position corresponding to the cache line locality classification in an eviction order of an eviction policy for the last level cache memory comprises:
selecting a first position configured to be evicted prior to a second position in response to determining the cache line locality classification for the evicted cache line is a first cache line locality classification, wherein the first cache line locality classification is configured to indicate cache line locality less than a second cache line locality classification; and
selecting the second position in response to determining the cache line locality classification for the evicted cache line is the second cache line locality classification.

14. The computing device of claim 9, wherein the cache memory manager is configured to perform operations further comprising:
determining a victim cache line of the last level cache memory based on a locality classification datum of the victim cache line; and
evicting the victim cache line from the last level cache memory,
wherein:
inserting the evicted cache line into the last level cache memory comprises inserting the evicted cache line into a cache line in the last level cache memory vacated by evicting the victim cache line from the last level cache memory; and
updating a cache line locality classification datum for the inserted cache line comprises updating the cache line locality classification datum in a cache line locality classification field in the in the cache line in the last level cache memory.

15. The computing device of claim 14, wherein:
the cache memory manager is configured to perform operations such that determining a victim cache line of the last level cache memory based on a locality classification datum of the victim cache line comprises determining whether a victim cache line candidate has a first locality classification; and
the cache memory manager is configured to perform operations further comprising determining whether the victim cache line candidate has a second locality classification in response to determining that the victim cache line does not have a first locality classification.

16. The computing device of claim 14, wherein:
the cache memory manager is configured to perform operations such that determining a victim cache line of the last level cache memory based on a locality classification datum of the victim cache line comprises determining whether a victim cache line candidate has a first locality classification; and
the cache memory manager is configured to perform operations further comprising:
determining whether multiple victim cache line candidates have the first locality classification in response to determining that the victim cache line candidate has the first locality classification; and
selecting the victim cache line from the multiple victim cache line candidates based on a position in an eviction order of an eviction policy for the last level cache memory in response to determining that the multiple victim cache line candidates have the first locality classification.

17. A computing device, comprising:
means for receiving a cache access request for a cache line in a higher level cache memory;
means for updating a cache line reuse counter datum configured to indicate a number of accesses to the cache line in the higher level cache memory during a reuse tracking period in response to receiving the cache access request;
means for evicting the cache line from the higher level cache memory;
means for determining a cache line locality classification for the evicted cache line based on the cache line reuse counter datum;
means for inserting the evicted cache line into a last level cache memory; and
means for updating a cache line locality classification datum for the inserted cache line.

18. The computing device of claim 17, wherein means for updating a cache line reuse counter datum configured to indicate a number of accesses to the cache line during a reuse tracking period in response to receiving the cache access request comprises means for updating the cache line reuse counter datum in a cache line reuse counter field in the cache line in the higher level cache memory.

19. The computing device of claim 17, wherein:
means for inserting the evicted cache line into a last level cache memory comprises means for inserting the evicted cache line into a cache line in the last level cache memory; and
means for updating a cache line locality classification datum for the inserted cache line comprises means for updating the cache line locality classification datum in a cache line locality classification field in the cache line in the last level cache memory.

20. The computing device of claim 17, wherein means for determining a cache line locality classification for the evicted cache line based on the cache line reuse counter datum comprises means for comparing the cache line reuse counter datum to a locality classification threshold,
the computing device further comprising:
means for selecting a first position corresponding to the cache line locality classification in an eviction order of an eviction policy for the last level cache memory and configured to be evicted prior to a second position in response to determining the cache line locality classification for the evicted cache line is a first cache line locality classification, wherein the first cache line locality classification is configured to indicate cache line locality less than a second cache line locality classification; and
means for selecting the second position corresponding to the cache line locality classification in the eviction order of the eviction policy for the last level cache memory and in response to determining the cache line locality classification for the evicted cache line is the second cache line locality classification.

21. The computing device of claim 17, further comprising:
means for determining a victim cache line of the last level cache memory based on a locality classification datum of the victim cache line; and
means for evicting the victim cache line from the last level cache memory,
wherein:
means for inserting the evicted cache line into a last level cache memory comprises means for inserting the evicted cache line into a cache line in the last level cache memory vacated by evicting the victim cache line from the last level cache memory; and
means for updating a cache line locality classification datum for the inserted cache line comprises means for updating the cache line locality classification datum in a cache line locality classification field in the in the cache line in the last level cache memory.

22. The computing device of claim 21, wherein means for determining a victim cache line of the last level cache memory based on a locality classification datum of the victim cache line comprises means for determining whether a victim cache line candidate has a first locality classification,
the computing device further comprising means for determining whether the victim cache line candidate has a second locality classification in response to determining that the victim cache line does not have a first locality classification.

23. The computing device of claim 21, wherein means for determining a victim cache line of the last level cache memory based on a locality classification datum of the victim cache line comprises means for determining whether a victim cache line candidate has a first locality classification,
the computing device further comprising:
means for determining whether multiple victim cache line candidates have the first locality classification in response to determining that the victim cache line candidate has the first locality classification; and
means for selecting the victim cache line from the multiple victim cache line candidates based on a position in an eviction order of an eviction policy for the last level cache memory in response to determining that the multiple victim cache line candidates have the first locality classification.

24. A non-transitory processor-readable storage medium having stored thereon processor-executable instructions configured to cause a processor of a computing device to perform operations comprising:
receiving a cache access request for a cache line in a higher level cache memory;
updating a cache line reuse counter datum configured to indicate a number of accesses to the cache line in the higher level cache memory during a reuse tracking period in response to receiving the cache access request;
evicting the cache line from the higher level cache memory;
determining a cache line locality classification for the evicted cache line based on the cache line reuse counter datum;
inserting the evicted cache line into a last level cache memory; and
updating a cache line locality classification datum for the inserted cache line.

25. The non-transitory processor-readable storage medium of claim 24, wherein the stored processor-executable instructions are configured to cause a processor of a computing device to perform operations such that updating a cache line reuse counter datum configured to indicate a number of accesses to the cache line during a reuse tracking period in response to receiving the cache access request comprises updating the cache line reuse counter datum in a cache line reuse counter field in the cache line in the higher level cache memory.

26. The non-transitory processor-readable storage medium of claim 24, wherein the stored processor-executable instructions are configured to cause a processor of a computing device to perform operations such that:
inserting the evicted cache line into a last level cache memory comprises inserting the evicted cache line into a cache line in the last level cache memory; and
updating a cache line locality classification datum for the inserted cache line comprises updating the cache line locality classification datum in a cache line locality classification field in the cache line in the last level cache memory.

27. The non-transitory processor-readable storage medium of claim 24, wherein:
the stored processor-executable instructions are configured to cause a processor of a computing device to perform operations such that determining a cache line locality classification for the evicted cache line based on the cache line reuse counter datum comprises comparing the cache line reuse counter datum to a locality classification threshold; and
the stored processor-executable instructions are configured to cause a processor of a computing device to perform operations further comprising:
selecting a first position corresponding to the cache line locality classification in an eviction order of an eviction policy for the last level cache memory and configured to be evicted prior to a second position in response to determining the cache line locality classification for the evicted cache line is a first cache line locality classification, wherein the first cache line locality classification is configured to indicate cache line locality less than a second cache line locality classification; and
selecting the second position corresponding to the cache line locality classification in the eviction order of the eviction policy for the last level cache memory and in response to determining the cache line locality classification for the evicted cache line is the second cache line locality classification.

28. The non-transitory processor-readable storage medium of claim 24, wherein the stored processor-executable instructions are configured to cause a processor of a computing device to perform operations further comprising:
determining a victim cache line of the last level cache memory based on a locality classification datum of the victim cache line; and
evicting the victim cache line from the last level cache memory,
wherein:
inserting the evicted cache line into a last level cache memory comprises inserting the evicted cache line into a cache line in the last level cache memory vacated by evicting the victim cache line from the last level cache memory; and
updating a cache line locality classification datum for the inserted cache line comprises updating the cache line locality classification datum in a cache line locality classification field in the in the cache line in the last level cache memory.

29. The non-transitory processor-readable storage medium of claim 28, wherein:
the stored processor-executable instructions are configured to cause a processor of a computing device to perform operations such that determining a victim cache line of the last level cache memory based on a locality classification datum of the victim cache line comprises determining whether a victim cache line candidate has a first locality classification; and
the stored processor-executable instructions are configured to cause a processor of a computing device to perform operations further comprising determining whether the victim cache line candidate has a second locality classification in response to determining that the victim cache line does not have a first locality classification.

30. The non-transitory processor-readable storage medium of claim 28, wherein:
the stored processor-executable instructions are configured to cause a processor of a computing device to perform operations such that determining a victim cache line of the last level cache memory based on a locality classification datum of the victim cache line comprises determining whether a victim cache line candidate has a first locality classification; and
the stored processor-executable instructions are configured to cause a processor of a computing device to perform operations further comprising:
determining whether multiple victim cache line candidates have the first locality classification in response to determining that the victim cache line candidate has the first locality classification; and
selecting the victim cache line from the multiple victim cache line candidates based on a position in an eviction order of an eviction policy for the last level cache memory in response to determining that the multiple victim cache line candidates have the first locality classification.
